(19) United States
(12) Patent Application Publication
(10) Pub. No.: US 2016/0144526 A1
(43) Pub. Date: May 26, 2016

(54) INSTALLATION TOOLS, SYSTEMS, AND METHODS FOR FLEXIBLE PROFILE MOLDINGS, SUCH AS WINDOW FILM ADHESIVE ATTACHMENT ARTICLES

(71) Applicant: 3M INNOVATIVE PROPERTIES COMPANY, Saint Paul, MN (US)

(72) Inventors: MICHAEL K. DOMROESE, WOODBURY, MN (US); PAUL A. NEUMANN, SAINT PAUL, MN (US); PAULINE E. LUDWIG, NEUSS (DE); ANDREAS HÖFER, DORMAGEN (DE)

(73) Assignee: 3M INNOVATIVE PROPERTIES COMPANY, Saint Paul, MN (US)

(21) Appl. No.: 14/903,346

(22) PCT Filed: Jun. 26, 2014
(86) PCT No.: PCT/US14/44260

§ 371 Date: Jan. 7, 2016

Related U.S. Application Data
(60) Provisional application No. 61/843,687, filed on Jul. 8, 2013.

(51) Int. Cl. B26D 7/01; B26D 5/10; B27G 5/04; B26D 1/04

(52) U.S. Cl. CPC B26D 7/01; B26D 1/04; B26D 5/10; B27G 5/04

(57) ABSTRACT

A tool useful with a flexible profile molding, for example a window film securement article having a self-adhesive coating. The tool includes a housing, a blade assembly and a cutting plate. The housing defines a cavity. The blade assembly is coupled to the housing and includes a blade disposed within the cavity. The cutting plate is selectively mountable to the housing, and includes a first profile and an optional second profile projecting from opposite faces of a platform. When present, the second profile is different from the first profile. Each profile is configured to retain a flexible profile molding in a flexed cutting condition during a cutting operation. In a first cutting state, the cutting plate is arranged such that the first profile faces the blade. In an optional second cutting state, the second profile faces the blade. The blade can be flat, with the cutting plate profile(s) dictating an arrangement of the flexible profile molding conducive to forming a curved miter cut with the flat blade.

### BACKGROUND

The present disclosure relates to installation tools. More particularly, it relates to hand tools and systems for preparing and installing flexible profile moldings, for example installing flexible profile moldings in the form of an adhesive attachment articles to a window film-protected window.

Window films are commonly applied to ordinary window glass, such as, for example, existing windows in commercial buildings or residences, to enhance the impact resistance and other properties of the window. Such window films are available from 3M Company, St. Paul, Minn., under the trade designation 3M Ultra Safety and Security window film. These and other window films provide protection against, for example, storm damage, earthquakes, explosions and “smash-and-grab” burglaries.

As a point of reference, a “window” generally consists of a window glass (or pane or glazing) mounted to a window frame. With this in mind, window films typically have an adhesive backing construction and are thus adhesively bonded to the window glass. Edges of the window film can be additionally secured to the frame by articles commonly known in the art as a film attachment system for example those described in U.S. Pat. No. 5,992,107 (Poirier), U.S. Pat. No. 6,931,799 (Webb), and US Application Publication No. 2009/0151255 (Haak), the teachings of each of which are incorporated herein by reference. These mounting articles are conventionally applied by hand (i.e., without the aid of a tool) along the edge of the window film and along the adjacent edge portion of the window frame such that, in the event of an impact to the window glass, the window film holds the shattered glass in place, and the mounting article serves to hold the window film and the adhered shattered glass to the window frame. By retaining the shattered glass in the window opening, the window film reduces the potential for flying glass to cause injuries to occupants of the building, and also prevents wind and rain from entering and damaging the interior of the structure.

The mounting articles referenced above are conventionally formed as extruded flexible profile moldings, establishing an adhesive-backed, profile shape that can be readily fitted to the corner formed between the window pane (and thus the window film applied thereto) and the window frame. Due to the extruded, adhesive-backed construction, this particular type of flexible profile molding can also be referred to as an elongate adhesive attachment article as described, for example, in US Publication No. 2009/0151255. As used throughout the present disclosure, an “adhesive attachment article” is in reference to a certain type or category of flexible profile molding; the term “flexible profile molding” is thus broader than, but inclusive of, an “adhesive attachment article”.

An exemplary elongate adhesive attachment article 10 is shown in isolation in FIGS. 1A and 1B, and generally includes an elongate body having or defining a first leg portion 12a, a flexible connecting portion 12b, and a second leg portion 12c. The first and second leg portions 12a, 12c include adhesive surfaces 13a, 13c, respectively, which, during use, are bonded to the respective surfaces of a window film and a window frame. The adhesive surfaces 13a, 13c may be provided, for example, with a double-sided adhesive tape such as 3M VHB acrylic foam tape available from 3M Company, St. Paul, Minn. To protect the adhesive surfaces 13a, 13c prior to use, the adhesive surfaces 13a, 13c may be covered with a suitable release liner (not shown), as is known in the art.

The adhesive attachment article 10 can have the symmetrical shape and unitary construction as shown. Further, the adhesive attachment article 10 can be flexible (e.g. formed of an elastomeric material, such as EPDM rubber). With this configuration, the connecting portion 12b can readily flex from the initial extruded state or shape of FIG. 1A to the installed shape or state of FIG. 1B, spatially orienting the leg portions 12a, 12c for abutted interface with corresponding surfaces of a window. FIG. 1C illustrates the adhesive attachment article 10 applied to a window 14. The window 14 includes a window frame 16 maintaining a pane of widow glass or glazing 18. A window film 20 has been applied to an interior surface 22 of the glazing 18. The adhesive attachment article 10 is applied to the perimeter of the window film 20, and to adjacent edges of the window frame 16, thereby securing the window film 20 to the window frame 16.

One example of a commercially available elongate adhesive attachment article useful for window film-to-window frame mounting is an extruded rubber product available from 3M Company, St. Paul, Minn. under the trade designation IMPACT PROTECTION PROFILE. This flexible-mechanical type of attachment system offers a clean installation and consistent appearance. The location of the flexible connecting portion 12b to the leg portions 12a, 12c promotes a more favorable shear mode (versus peel mode) of adhesive strain, thereby providing a stronger adhesive bond when the attachment system is stressed by an applied force to the window.

While highly viable, elongate adhesive attachment articles for window film securement may require some level of installation expertise. As a point of reference, the adhesive attachment articles are conventionally supplied to the installer as elongated strips. The installer, in turn, cuts the strip(s) into segments or individual adhesive attachment articles, with each so-prepared article having a length generally corresponding with the length (or width) of the window perimeter. For example, a window perimeter can be described as having opposing length sides and opposing width sides. One (or more) of the elongated strips (as provided to the installer) is cut into four articles or segments; two corresponding with a dimension of the length sides and two corresponding with the width sides.

For aesthetic purposes and to better ensure uniform connection of the window film with the widow frame, it is recommended that the applied attachment articles slightly overlap one another at each corner of the widow perimeter (e.g., the adhesive attachment articles applied along the length sides will overlap (or be overlapped by) the adhesive attachment articles applied along the width sides). A more robust adhesion and professional appearance can be achieved by forming the cut end of at least one of the two overlapping adhesive attachment articles as an angled miter cut. With this technique, the adjacent adhesive attachment articles mate cleanly in the corners of the window frame. The mitered cut end should not abut against the adjacent adhesive attachment article, but instead neatly overlaps it. The overlapping arrangement beneficially establishes an interlocking joint-like arrangement, and elegantly accounts for the flexible nature of the adhesive attachment article and variations in the window frame contour. As a point of reference, an even butt joint is readily achieved between two rigid strips (e.g., wood) at a corner formed by the strips by simply forming a miter cut at the corresponding ends. The rigid strips do not change shape before, during or after cutting (i.e., as installed), meaning that the miter cut ends will maintain their shape following cutting and thus directly abut one another. This same relationship, however, is virtually impossible with flexible adhesive attachment articles; unlike a rigid strip, the installed shape of the adhesive attachment article differs dramatically from the pre-installation shape. That is to say, because the adhesive attachment article is flexed upon installation, a shape of a cut end formed in the adhesive attachment article in an un-flexed or natural state will change significantly upon final, flexed installation. An overlapping, interlocking joint-type arrangement eliminates possible discontinuities in the resultant seam and is much less subject to inevitable variations that occur during cutting.

Conventionally, the elongate adhesive attachment articles are cut, as part of the window film attachment system, with a commercially available anvil-type cutter. The anvil-type cutter is designed to make straight cuts through the material, and is highly appropriate for “straight” end cuts. Unfortunately, existing installation cutting tools are less proficient in forming the miter cuts described above. As a point of reference, the geometries and spatial orientations presented by the typical adhesive attachment articles change when transitioning from the initial extruded shape of FIG. 1A to the installed shape of FIG. 1B. Forming a “straight” miter cut in the initial shape of the adhesive attachment article does not translate into an appropriate orientation of the leg portions 12a, 12c edges when flexed to the installed shape and disposed over a previously-applied, adjacent adhesive attachment article. Instead, the miter cut edge in the installed state exhibits various curvatures that promote the desired, neatly overlapped appearance. Simply stated, cutting the miter profile with an anvil-type cutter is tedious and cannot consistently achieve the requisite curved shape. A shear profile-type cutter is sometimes used that, in the hands of a skilled installer, could more easily generate the required curved cuts, but this cutting technique is quite time consuming and results are variable at best depending upon the skill level of the installer. Further complicating matters, the adhesive attachment article 10 of FIG. 1A (as well as many other types of flexible profile moldings) require a differently contoured profile of the miter cut on the “front” side relative to the adhesive side. The particular shape of the cut is difficult to execute with an anvil cutter or shears. Unfortunately, installers often forget or poorly execute this step that can in turn reduce the overall quality of the film attachment system installation.

Additional adhesive attachment article-to-window film installation steps requiring some level of skill include initially aligning the adhesive attachment article relative to the corresponding window component (i.e., the window frame 16 or the glazing 18), and then applying proper force to activate the adhesive surfaces 13a, 13c. First, the adhesive attachment article 10 must be aligned and generally adhered to the corresponding window components. Once aligned, a force is applied by the installer on to the leg portions 12a, 12c, causing the adhesive surfaces 13a, 13c to more fully press against the corresponding window component. Because the leg portions 12a, 12c are quite close to one another while arranged at an approximately 90 degree angle, it can be difficult to uniformly align the attachment article relative to the window components, while simultaneously removing the liners (where provided). Similar constraints also impede consistent application of the requisite pressing forces. Various tools have been developed for assisting the installer with these tasks, including tools that can both align and apply pressing forces to the attachment article such as those described in U.S. Publication No. 2009/0320406 (Dyer). While useful, these alignment and force applying tools must be carried by the installer (in addition to the cutter(s) mentioned above), adding to the overall complexity of the installation process.

The cutting, alignment and/or force applying concerns noted above are not limited to adhesive attachment articles and their installation to windows. Installation of a wide variety of other flexible profile moldings (i.e., other than adhesive attachment articles utilized for window film-to-window frame attachment) also entail one or more of miter cut formation, installation alignment and/or pressing force application.

In light of the above, a need exists for tools that simplify the installation of elongate flexible profile moldings, such as, but not limited to, installation of adhesive attachment articles to window film-protected windows, including the formation of desired miter cuts. Optionally, these same tools facilitate performance of other installation tasks, such as attachment article alignment. Other installation tasks, such as application of required pressing forces, are also addressed.

### SUMMARY

Some aspects of the present disclosure relate to an installation tool useful for the installation of an elongate flexible profile molding, for example installation of an adhesive attachment article to a window film-protected window. Although descriptions of the present disclosure make reference to elongate adhesive attachment articles for installation to windows the tools, systems and methods of the present disclosure are equally applicable to any other type or format of flexible profile molding, including flexible profile moldings that do not include an adhesive. The installation tool includes a housing, a blade assembly and a cutting plate. The housing defines a cavity and opposing, first and second ends. The blade assembly is coupled to the housing and includes a blade disposed within the cavity. The cutting plate is selectively mountable to the second end of the housing, and includes a platform, a first profile and an optional second profile. The platform defines opposing, first and second major faces. The first profile projects from the first major face, whereas the second profile (when present) projects from the second major face. Each of the profiles is configured to retain an elongate flexible profile molding in a flexed condition, with the first profile differing from the optional second profile. With this construction, the tool is configured to provide a first cutting state and an optional second cutting state, with the cutting state(s) appropriate for effectuating a desired type of miter cut. In the first cutting state, the cutting plate is assembled to the housing such that the first profile faces the blade. In the second cutting state (where provided), the cutting plate is assembled to the housing such that the second profile faces the blade. A user is thus afforded the ability to quickly create a desired contoured cut line, for example a miter cut, by simply selecting the appropriate profile provided by the cutting plate and inserting the flexible profile molding into the tool, with the selected profile generating a flexed curvature into the flexible profile molding (e.g., toward or away from the blade). The blade can be a readily available utility knife blade or other straight blade. The cutting plate profiles dictate a flexed arrangement of the flexible profile molding relative to the straight blade that in turn effectuates a cut line or pattern exhibiting curves.

In some embodiments, the cutting plate is configured to be reversible relative to the housing. In other embodiments, the first profile is configured to promote formation of a first type of miter cut by the blade, and the second profile is configured to promote formation of a second type of miter cut. For example, the first profile can be conducive to a left end miter cut, whereas the optional second profile is conducive to a right end miter cut. In other embodiments, additional cutting plates are provided that are selectively mountable to the housing and present one or more additional, differing profiles suited for differing types or sizes of flexible profile moldings. In related embodiments, the blade assembly and housing are collectively configured to provide at least two different spatial orientations of the blade relative to the cutting plate, with each spatial orientation being well suited for a different type or size of flexible profile molding.

Other aspects of the present disclosure are directed toward methods of installing a flexible profile molding. In a natural or pre-installation condition, the flexible profile molding is naturally un-flexed and defines an un-flexed shape. The method includes inserting the flexible profile molding into an installation tool, with the installation tool forcing the flexible profile molding to a flexed cutting condition defining a flexed shape. The flexed shape differs from the un-flexed shape. The installation tool is operated to cut the flexible profile molding while in the flexed cutting condition, resulting in a flexible profile molding segment having a miter cut end. The flexible profile molding segment is removed from the installation tool and installed to a surface. In this regard, the miter cut end is substantially linear in the flexed cutting condition and is curved in the natural condition. In some embodiments, the flexible profile molding segment is an adhesive attachment article, and the step of installing to a surface includes installing the adhesive attachment article to a window film-protected window. In other embodiments, the step of installing the flexible profile molding segment to a surface includes flexing the flexible profile molding segment to a flexed installation condition having a flexed installation shape, the flexed installation shape differing from the flexed cutting shape and the un-flexed shape. In yet other embodiments, the method further includes arranging the installation tool to perform a left end miter cut or a right end miter cut prior to the step of inserting the flexible profile molding.

### BRIEF DESCRIPTION OF THE DRAWINGS

FIG. 1A is a simplified end view of an exemplary flexible profile molding, and in particular an adhesive attachment article in an initial, extruded un-flexed state or condition and with which tools of the present disclosure are useful;

FIG. 1B is a simplified perspective view of the adhesive attachment article of FIG. 1A in a flexed installed state or condition;

FIG. 1C illustrates mounting of the adhesive attachment article of FIG. 1A to a window film and window frame;

FIG. 2A is a side view of an installation tool in accordance with principles of the present disclosure;

FIG. 2B is a perspective, exploded view of the tool of FIG. 2A;

FIG. 3A is a perspective view of a cutting plate useful with the tool of FIG. 2A;

FIG. 3B is another perspective view of the cutting plate of FIG. 3A from a different vantage point;

FIG. 3C is a side view of the cutting plate of FIGS. 3A and 3B;

FIG. 4 is a perspective view of flexible profile molding supported at a flexed state by a first profile provided with the cutting plate of FIG. 3A;

FIG. 5 is a perspective view of flexible profile molding supported at a flexed state by a second profile provided with the cutting plate of FIG. 3A;

FIGS. 6A and 6B are differing perspective views of another cutting plate in accordance with principles of the present disclosure and useful with the tool of FIG. 2A;

FIG. 6C is a side view of the cutting plate of FIGS. 6A and 6B;

FIG. 7 is a perspective view of flexible profile molding supported at a flexed state by a first profile provided with the cutting plate of FIG. 6A;

FIG. 8 is a perspective view of flexible profile molding supported at a flexed state by a second profile provided with the cutting plate of FIG. 6A;

FIG. 9A is a bottom perspective view of a housing component of the tool of FIG. 2A;

FIG. 9B is an end view of the housing of FIG. 9A;

FIGS. 10A-10C illustrate mounting of the cutting plate of FIG. 3A to the housing of FIG. 9A in a first cutting state;

FIGS. 11A and 11B illustrate mounting of the cutting plate of FIG. 3A to the housing of FIG. 9A in a second cutting state;

FIGS. 12A and 12B are differing perspective views of a blade assembly useful with the tool of FIG. 2A;

FIG. 12C is an enlarged, perspective exploded view of clamp structure and blade components of the blade assembly of FIGS. 12A and 12B;

FIG. 12D is a top view of the clamp structure and blade components of the blade assembly of FIGS. 12A and 12B;

FIG. 13A is a perspective view of a housing component of the tool of FIG. 2A;

FIG. 13B is an exploded, perspective view of the housing of FIG. 13A;

FIG. 13C is a top view of a housing body portion of the housing of FIG. 13A, and illustrating a cavity;

FIGS. 14A and 14B illustrate mounting of portions of the blade assembly of FIG. 12A to the housing body cavity of FIG. 13C in differing spatial orientations of the blade;

FIGS. 15A and 15B are differing bottom perspective views of the tool of FIG. 2A and illustrating alignment surfaces provided by the housing;

FIG. 16 is a cross-sectional view of the tool of FIG. 2A;

FIG. 17A schematically illustrates a window installation environment, including a window pane, a window frame, and a window film applied to the pane;

FIG. 17B schematically illustrates an arrangement of flexible profile moldings to the window of FIG. 17A;

FIGS. 18A-18C illustrate use of the tool of FIG. 2A in forming a miter cut on a flexible profile molding, including the tool arranged in a first cutting state;

FIG. 18D illustrates use of the tool of FIG. 2A in forming a miter cut on a flexible profile molding, including the tool arranged in a second cutting state;

FIG. 18E is a bottom perspective view of the tool of FIG. 2A in combination with a flexible profile molding and illustrating use of an optional viewing pocket provided with the tool;

FIG. 18F is a photograph depicting a miter cut end formed in a flexible profile molding with the tool of FIG. 2A with the flexible profile molding forced to a flexed cutting condition;

FIG. 18G is a photograph depicting the miter cut end of the flexible profile molding of FIG. 18F with the flexible profile molding in a natural or un-flexed condition;

FIG. 19 illustrates use of the tool of FIG. 2A in aligning a flexible profile molding relative to a window; and

FIG. 20 is a perspective view of a roller tool in accordance with principles of the present disclosure.

### DETAILED DESCRIPTION

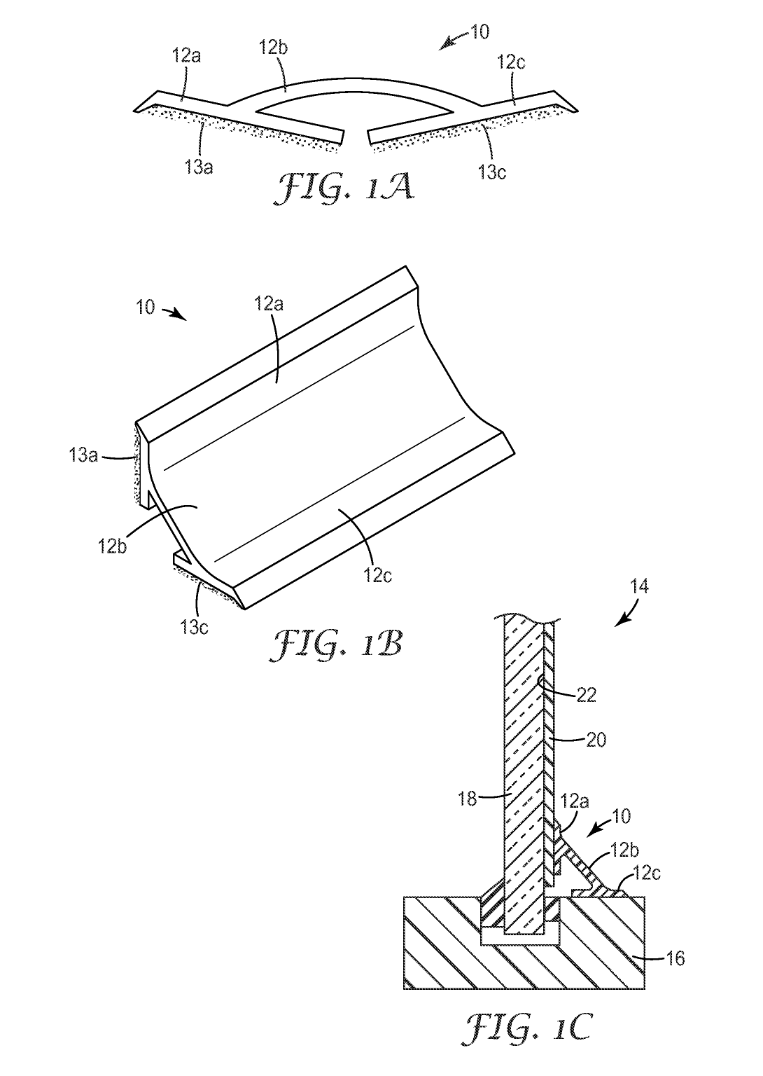

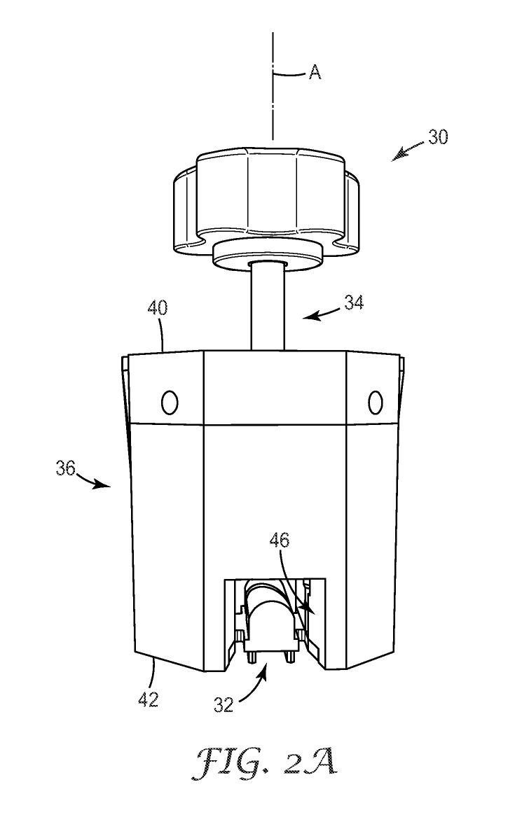

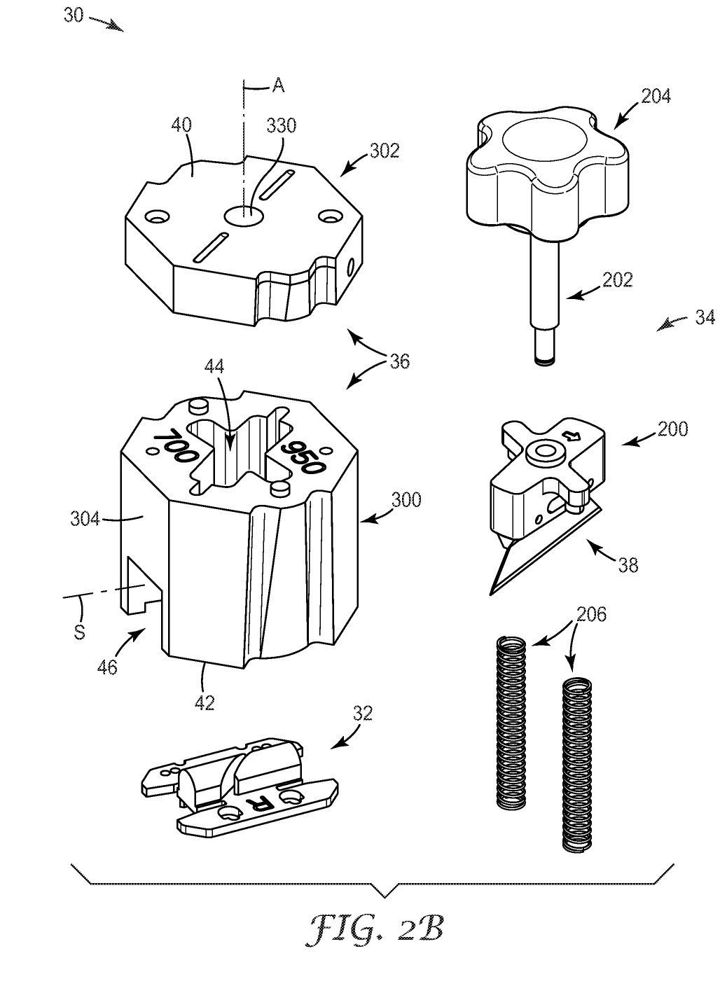

One embodiment of an installation tool 30 for use in the installation of an elongate flexible profile molding to a substrate (e.g., the adhesive attachment article 10 to window 16 installation of FIG. 1C) is shown in FIGS. 2A and 2B (it being understood that the flexible profile molding is not illustrated in FIGS. 2A or 2B). The tool 30 facilitates formation of a miter cut in the elongate flexible profile molding, and includes a cutting plate 32, a blade assembly 34 (referenced generally) and a housing 36. Details on the various components are provided below. In general terms, however, the blade assembly 34 is maintained by the housing 36 and includes a blade 38 (visible in FIG. 2B). The cutting plate 32 is selectively mounted to the housing 36, and provides (as described below) a first profile and an optional second profile. In this regard, the cutting plate 32 is assembled to the housing 36 so as to obtain the desired orientation of the cutting plate 32 relative to the blade 38. During use of the tool 30 in forming a miter cut, the flexible profile molding is inserted into the housing 36, and is forced to (e.g., flexed) and supported at a spatial shape or condition conducive to desired miter cut formation by the selected profile of the cutting plate 32. By optionally providing the two, differing cutting plate profiles, the tool 30 can be used to form differing miter cuts in a flexible profile molding for reasons made clear below. In some embodiments, the tool 30 incorporates additional features that promote cutting of differently-sized flexible profile moldings and/or for performing other installation tasks, such as flexible profile molding-to-substrate alignment as described below. As a point of reference, the tool 30 can be described as defining or having a central, longitudinal axis A relative to which various components can be referenced (e.g., reference to “longitudinal”, “longitudinally” or “longitudinal direction” is along the longitudinal axis A, whereas “radial”, “radially” or “radial direction” is radial to the longitudinal axis A). A cutting action is effectuated by moving the blade 38 relative to the cutting plate 32 in the longitudinal direction.

The cutting plate 32, the blade assembly 34, and the housing 36 can incorporate inter-related features that promote assembly and subsequent use of the tool 30 in creating a flexible profile molding miter cut. As such, features of the cutting plate 32 may be better understood with a brief explanation of some general features of the housing 36. In general terms, the housing 36 extends between first and second ends 40, 42, and forms a cavity 44 (visible in FIG. 2B) and a slot 46. The blade 38 is slidably maintained within the cavity 44 that is otherwise open to the slot 46. The slot 46, and thus the cavity 44, is open to the second end 42. The cutting plate 32 is mounted to the second end 42. The cavity 44 is generally aligned with the longitudinal axis A, whereas the slot 46 extends through the housing 36 in a radial direction, generating a slot axis S. Upon final assembly of the tool 30, a flexible profile molding (not shown) is inserted into and through the slot 46, with the cutting plate 32 dictating an arrangement or shape (e.g., flexed condition) of the flexible profile molding as presented to the blade 38 (otherwise within the cavity 44). As the blade 38 is moved longitudinally through the cavity 44 (toward the cutting plate 32) and into contact with the flexible profile molding, the cutting plate 32 supports the flexible profile molding in the dictated flexed shape or condition to complete the desired miter cut.

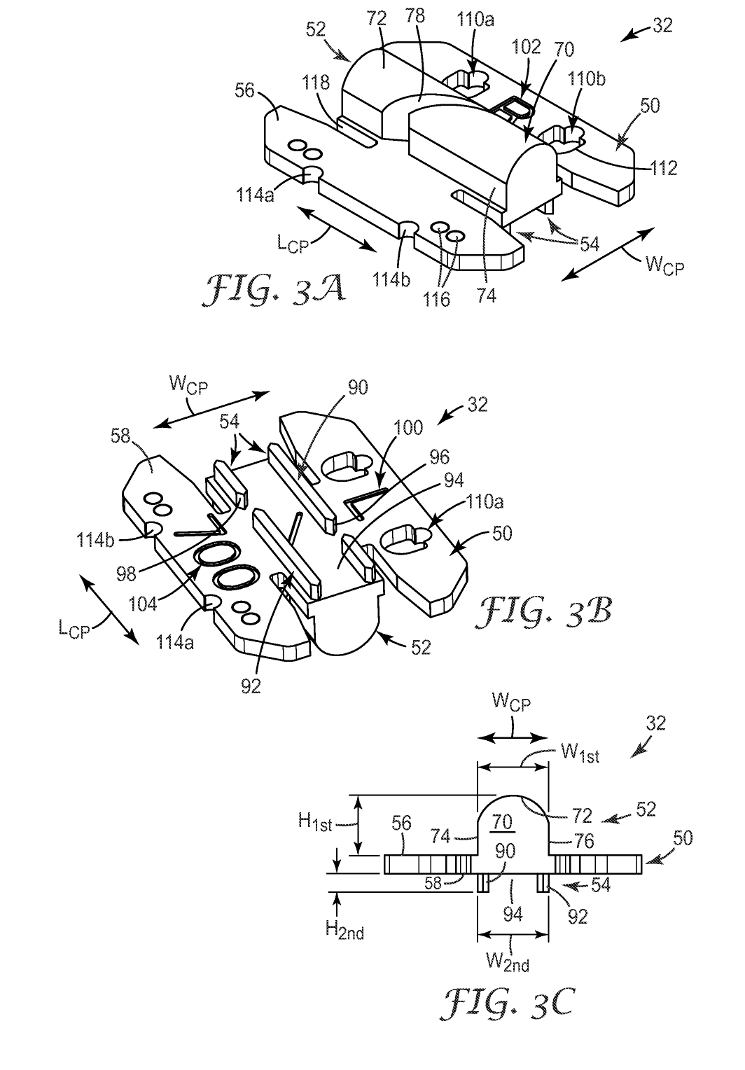

With the above general context in mind, one embodiment of the cutting plate 32 is shown in FIGS. 3A and 3B, and includes a platform 50, a first profile 52 and an optional second profile 54. The platform 50 defines opposing first and second major faces 56, 58 with the first profile 52 projecting from the first major face 56, and the second profile 54 projecting from the second major face 58. As described below, the first profile 52 and the second profile 54 (when provided) differ from one another in terms of size, shape and contour for effectuating differing flexed conditions or shapes in the flexible profile molding.

The cutting plate 32 can be formed as a homogenous or integral body, from a material resistant to wear following repeated contact with the blade 38 (FIG. 2B) (e.g., aluminum, stainless steel, etc.). The platform 50 can have a flattened construction, forming the first and second major faces 56, 58 to be substantially flat (e.g., within 10% of a truly flat surface). As described below, the platform 50 optionally incorporates one or more additional features that facilitate assembly to the housing 36 (FIG. 2A).

Regardless, extension of the profiles 52, 54 relative to a perimeter shape of the platform 50 establishes cutting plate length and width directions L_{CP}, W_{CP}. As a point of reference, upon final assembly of the tool 30 (FIG. 2A), the cutting plate length direction L_{CP} will be aligned with the slot axis S (FIG. 2B).

The first profile 52 is best seen in FIG. 3A and includes or comprises a support wall 70 projecting from the first major face 56. The support wall 70 terminates at a leading edge 72 opposite the first major face 56. With additional reference to FIG. 3C, the leading edge 72 can be curved, such that the support wall 70 has an arch-like shape. Opposing side edges 74, 76 are defined between the leading edge 72 and the first major face 56, and in some embodiments are substantially flat. The support wall 70 can be centrally disposed along the platform 50 relative to the cutting plate width direction W_{CP}, and uniformly forms the described profile shape along the cutting plate length direction L_{CP} except at an optional notch 78. Thus, the support wall 70 can be viewed as having an elongated shape, including a length in the cutting plate length direction L_{CP}. The notch 78, where provided, represents an interruption in the support wall 70, and is sized and shaped to receive the blade 38 (FIG. 2B) in connection with a cutting operation. In some embodiments, the notch 78 can be formed at a non-perpendicular angle relative to the length of the support wall 70, commensurate with a spatial orientation of the blade 38 as described below.

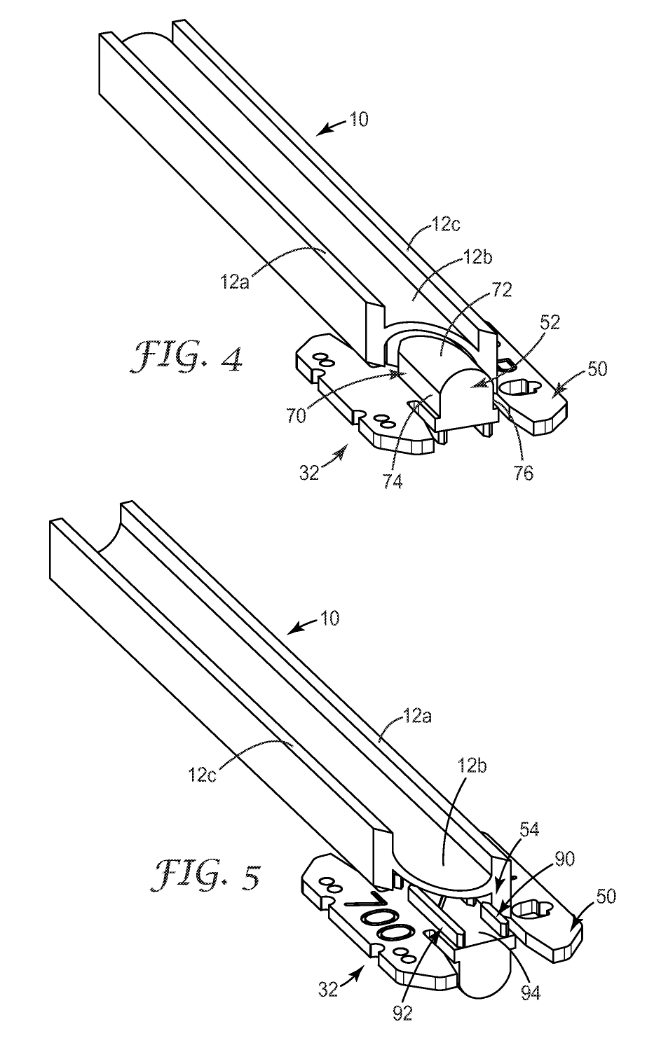

The curved, substantially continuous shape of the leading edge 72, along with other features of the support wall 70 described below, render the first profile 52 highly useful in effectuating a particular type of miter cut in a flexible profile molding, for example what can be referred to as a “left end” miter cut. Left end miter cuts (as well as “right end” miter cuts) are described in greater detail below. In this regard, FIG. 4 illustrates the flexible profile molding 10 supported at a shape dictated by the first profile 52 (and following completion of a cutting operation). As shown, the connecting portion 12b contacts the leading edge 72, and is forced to a flexed, curved shape or condition commensurate with a curvature of the leading edge 72 (e.g., the connecting portion 12b is forced to a convex curve relative to the platform 50). The leg portions 12a, 12c generally abut the side edges 74, 76, respectively. With this in mind, and with additional reference to FIG. 3C, height and width components H₁ₛₜ, W₁ₛₜ of the first profile 52 can be selected in accordance with expected, corresponding dimensions of the particular flexible profile molding 10 being worked on, and in particular to effectuate the above described convex curvature in the connecting portion 12b while arranging the leg portions 12a, 12c to be substantially parallel (e.g., within 10% of a truly parallel relationship). In some embodiments and as made clear below, by flexing the flexible profile molding into a shape (or flexed condition) that differs from a natural, un-flexed shape as well as from a shape of the flexible profile molding upon final installation (e.g., in some embodiments, the installed flexible profile molding will be flexed (i.e., a flexed installed condition) such that the leg portions 12a, 12c are substantially perpendicular (as compared to the substantially parallel relationship in the flexed cutting condition dictated by the first profile 52)), a contoured or curved miter cut can be generated by the tool 30 using a straight blade. With other constructions of the flexible profile molding 10 having geometries or dimensional relationships differing from those implicated by FIG. 4, one or more of the height H₁ₛₜ, width W₁ₛₜ, or curvature of the leading edge 72 attributes can vary accordingly. In some embodiments, however, a length of the support wall 70 (i.e., dimension in the cutting plate length direction L_{CP} (FIG. 3A)) is less dependent upon the format or geometry of the particular flexible profile molding 10, if at all.

The optional second profile 54 is best seen in FIG. 3B and includes or comprises first and second spaced apart ribs 90, 92 projecting from the second major face 58. The ribs 90, 92 can be substantially identical in terms of size and shape, and have an elongated length extending in the cutting plate length direction L_{CP}. The ribs 90, 92 are substantially parallel (e.g., within 5% of a truly parallel relationship), separated by a gap 94. As reflected by FIG. 3C, a width W_{2nd} of the second profile 54 (collectively established by the ribs 90, 92) can approximate the first profile width W₁ₛₜ. However, a height H_{2nd} of the second profile 54 is less than the first profile height H₁ₛₜ. In some embodiments, the ribs 90, 92 have a continuous, uniform shape in the cutting plate length direction L_{CP}, except at an optional notch 96, 98. Where provided, each notch 96, 98 is sized to receive the blade 38 (FIG. 2B) in connection with a cutting operation. In some embodiments, the notch 96 in the first rib 90 is not transversely aligned with the notch 98 in the second rib 92; instead, the notches 96, 98 collectively define an angle commensurate with a spatial orientation of the blade 38 as described below.

The spaced apart, linear arrangement of the ribs 90, 92, along with other dimensional features described below, render the second profile 54 highly useful in effectuating a particular type of miter cut in a flexible profile molding differing from that of the first profile 52, for example what can be referred to as a “right end” miter cut. In this regard, FIG. 5 illustrates the flexible profile molding 10 supported at a flexed cutting condition or shape dictated by the second profile 54 (and following completion of a cutting operation). As shown, the connecting portion 12b is forced to a flexed, curved shape that nests within the gap 94 (e.g., the connecting portion 12b is forced to a concave curve relative to the platform 50) and contacts the ribs 90, 92. The leg portions 12a, 12c generally abut the ribs 90, 92, respectively. With this in mind, and with additional reference to FIG. 3C, the height and width components H_{2nd}, W_{2nd} of the second profile 54 can be selected in accordance with expected, corresponding dimensions of the particular flexible profile molding 10 being worked on, and in particular to effectuate and support the above described flexed cutting condition (e.g., concave curvature in the connecting portion 12b while arranging the leg portions 12a, 12c to be substantially parallel (e.g., within 10% of a truly parallel relationship)). For example, the height H_{2nd} of the ribs 90, 92 is selected to contact the connecting portion 12b when concavely flexed. The width W_{2nd} established by the ribs 90, 92 accommodates a desired distance between the leg portions 12a, 12c when the connecting portion 12b is flexed. Finally, the gap 94 is sized and shaped to receive the flexed connecting portion 12b. With other constructions of the flexible profile molding 10 having geometries or dimensional relationships differing from those implicated by FIG. 5, one or more of the height H_{2nd}, width W_{2nd}, or gap 94 dimensional attributes can vary accordingly. In some embodiments, however, a length of the ribs 90, 92 (i.e., dimension in the cutting plate length direction L_{CP} (FIG. 3B)) is less dependent upon the format or geometry of the particular flexible profile molding 10, if at all.

Returning to FIGS. 3A and 3B, in some embodiments, the cutting plate 32 includes only one of the first profile 52 or the second profile 54. With constructions including both of the profiles 52, 54, the cutting plate 32 can optionally include nomenclature or other indicators that provide a visual cue as to the format or type of miter cut implicated by the first and second profiles 52, 54, for example first profile indicia 100 (FIG. 3B) and second profile indicia 102 (FIG. 3A). The first profile indicia 100 is indicative of the cut type to be effectuated by the first profile 52, and is formed or carried by the second major face 58. As a point of reference, when the cutting plate 32 is installed to the housing 36 (FIG. 2A) so as to present the first profile 52 to the blade 38 (FIG. 2B), the second major face 58 will be visible to the user (i.e., although the first profile 52 projects from the first major face 56, the first major face 56 will not be readily visible to a user upon final assembly of the cutting plate 32 to the housing 36 such that providing the first profile indicia 100 on the opposite, but otherwise visible, second major face 58 may be beneficial). The first profile indicia 100 can assume various forms, and in one embodiment is the letter “L” that otherwise indicates that the first profile 52 is appropriate for forming a left end miter cut. Similarly, FIG. 3A shows the second profile indicia 102 formed or carried by the first major face 56 and is indicative of the type of cut to be effectuated by the second profile 54. The second profile indicia 102 can assume various forms, and in one embodiment is the letter “R” that otherwise indicates that the second profile 54 is appropriate for forming a right end miter cut. Other cut type indicators and locations are also acceptable. As a point of reference, FIG. 3B further illustrates an optional, article identification indicia 104. As made clear below, in some embodiments of the present disclosure, two (or more) differently-configured cutting plates 32 are available to a user, with the user selecting the desired cutting plate 32 based upon the particular type or size of flexible profile molding to be cut. In this regard, the article identification indicia 104, where provided, can provide an indication of the type of flexible profile molding to be used with the corresponding cutting plate 32 (regardless of the type of cut to be made). The article identification indicia 104 can be formed on or carried by one or both of the major faces 56, 58, and in other embodiments can be eliminated.

The cutting plate 32 optionally includes one or more additional features that facilitate selective coupling to the housing 36 (FIG. 2A). For example, the platform 50 can form one or more capture slots 110a, 110b each defining an enlarged end 112. One or more grooves 114a, 114b can also be formed, with the slots 110a, 110b and the grooves 114a, 114b each sized and shaped to slidably interface with corresponding features of the housing 36 as described below. Further, the cutting plate 32 optionally forms one or more bores 116 within which a metal dowel (not shown) is retained. As described below, the housing 36 can incorporate one or more magnets strategically located to magnetically attract the metal dowels in providing a more robust, but selective, “lock” with the cutting plate 32 in a desired position. Finally, the platform 50 can optionally form one or more viewing pockets 118 through which a user can visually estimate the location of a cut line to be generated by the tool 30 (FIG. 2A) along a flexible profile molding loaded into the tool 30 as described below.

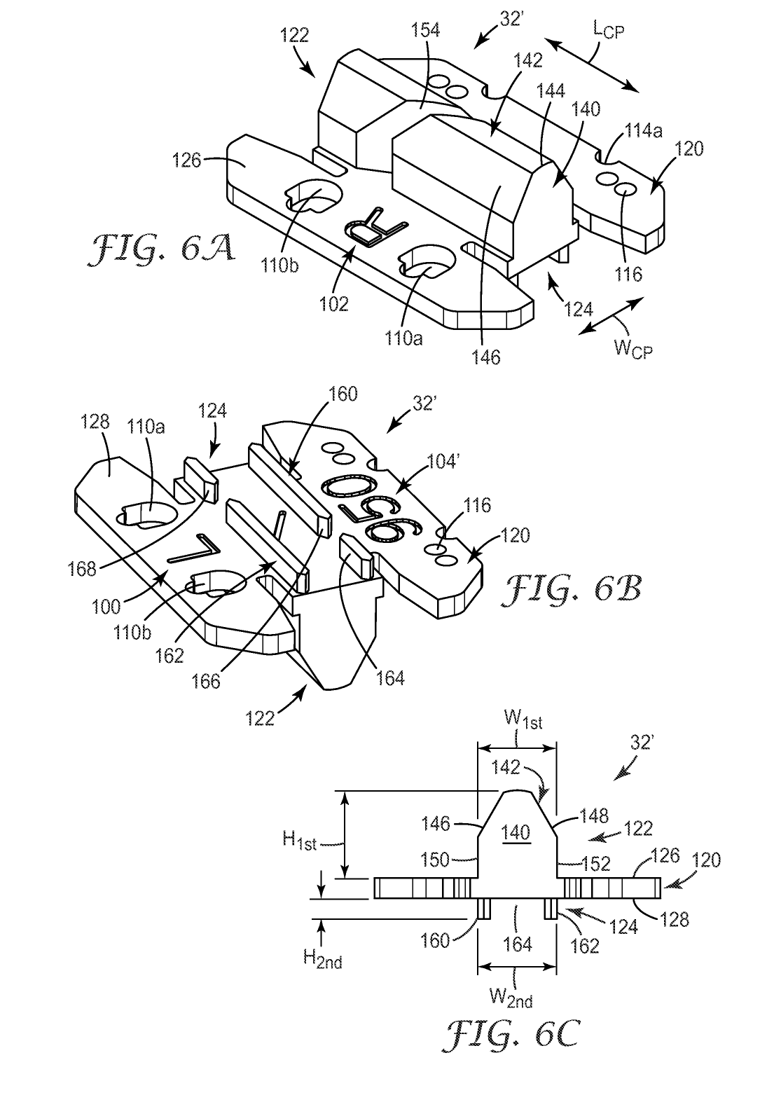

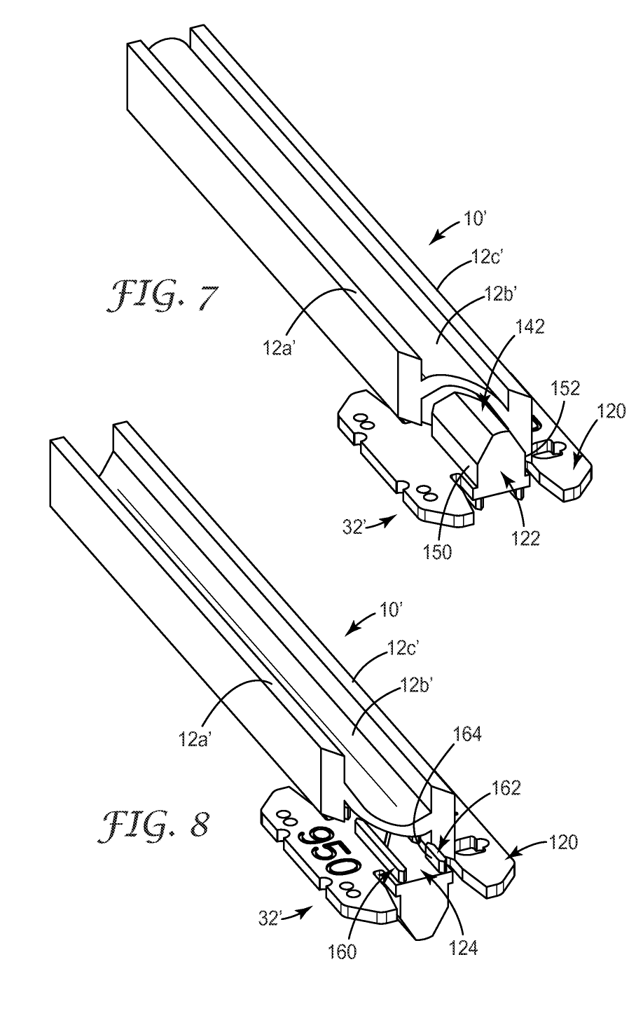

As implicated by the above, the first and second profiles 52, 54 can incorporate geometrical features differing from the above descriptions and/or two or more cutting plates 32 having differing profiles can be made available to a user in some embodiments. With this in mind, another embodiment cutting plate 32′ in accordance with principles of the present disclosure (and useful with the tool 30 of FIGS. 2A and 2B) is shown in FIGS. 6A and 6B. The cutting plate 32′ is akin to the cutting plate 32 (FIGS. 3A and 3B), and includes or defines a platform 120, a first profile 122 and an optional second profile 124. The platform 120 defines opposing first and second major faces 126, 128, with the first profile 122 projecting from the first major face 126, and the second profile 124 (when provided) projecting from the second major face 128. Once again, the first and second profiles 122, 124 differ from one another in terms of size, shape and contour for effectuating differing flexible profile molding flexed cutting conditions or arrangements. Although similar in many respects to the first and second profiles 52, 54, respectively, the first and second profiles 122, 124 of the cutting plate 32′ are configured to interface with a larger sized (e.g., larger width) flexible profile molding

The first profile 122 is best seen in FIG. 6A and includes or comprises a support wall 140 projecting from the first major face 126. The support wall 140 terminates at a leading edge 142 opposite the first major face 126. With additional reference to FIG. 6C, the leading edge 142 defines a central segment 144 and opposing outer segments 146, 148. The central segment 144 can have a slight convex curvature. The outer segments 146, 148 extend from opposing side edges 150, 152, respectively, of the support wall 140, and can be relatively flat. A width W₁ₛₜ of the first profile 122 tapers along the outer segments 146, 148 to the central segment 144 such that the support wall 140 has an arch-like shape. The support wall 140 can be centrally disposed along the platform 120 relative to the cutting plate width direction W_{CP}, and uniformly forms the described profile shape along the cutting plate length direction L_{CP} except at an optional notch 154 that is sized and shaped to receive the blade 38 (FIG. 2B) as described above.

The substantially continuous arch-like shape of the first profile 122, along with other features of the support wall 140 described below, render the first profile 122 highly useful for effectuating a particular type of miter cut in a flexible profile molding, for example a left end miter cut. In this regard, FIG. 7 illustrates a flexible profile molding 10′ supported at a shape dictated by the first profile 122 (and following completion of a cutting operation). As a point of reference, the flexible profile molding 10′ has a larger width than the flexible profile molding 10 shown in FIG. 4, but is otherwise similarly shaped. In the flexed cutting condition, the connecting portion 12b′ contacts the leading edge 142, and is forced to (and supported at) a flexed, curved or curvilinear shape commensurate with an overall curvature of the leading edge 142 (e.g., the connecting portion 12b′ is forced to a convex or convex-like shape relative to the platform 120). The leg portions 12a′, 12c′ generally abut the side edges 150, 152, respectively. With this in mind, and with additional reference to FIG. 6C, height and width components H₁ₛₜ, W₁ₛₜ of the first profile 122 are selected in accordance with expected, corresponding dimensions of the particular flexible profile molding 10′ being worked on, and in particular to effectuate the above described convex curvature in the connecting portion 12b′ while arranging the leg portions 12a′, 12c′ to be substantially parallel (e.g., within 10% of a truly parallel relationship). With other constructions of the flexible profile molding 10′ having geometries or dimensional relationships differing from those implicated by FIG. 7, one or more of the height H₁ₛₜ, width W₁ₛₜ, or curve-like shape of the leading edge 142 attributes can vary accordingly.

Returning to FIGS. 6B and 6C, when provided the second profile 124 can be highly akin to the second profile 54 (FIG. 3B) described above, and includes first and second spaced apart ribs 160, 162 projecting from the second major face 128. The ribs 160, 162 can be substantially identical in terms of size and shape, and have an elongated length extending in the cutting plate length direction L_{CP} (FIG. 6A). The ribs 160, 162 are substantially parallel (e.g., within 5% of a truly parallel relationship), separated by a gap 164. As reflected by FIG. 6C, a width W_{2nd} of the second profile 124 (collectively established by the ribs 160, 162) can approximate the first profile width W₁ₛₜ. However, a height H_{2nd} of the second profile 124 is less than the first profile height H₁ₛₜ. In some embodiments, the ribs 160, 162 have a continuous, uniform shape in the cutting plate length direction L_{CP}, except at an optional notch 166, 168 sized to receive the blade 38 (FIG. 2B) as described above.

The spaced apart, linear arrangement of the ribs 160, 162 along with other dimensional features described below, render the second profile 124 highly useful in effectuating a particular type of miter cut in a flexible profile molding differing from that of the first profile 122, for example a right end miter cut. In this regard, FIG. 8 illustrates the flexible profile molding 10′ supported at a flexed cutting condition or shape dictated second profile 124 (and following completion of a cutting operation). As shown, the connecting portion 12b′ is forced to a flexed, curved shape that nests within the gap 164 (e.g., the connecting portion 12b′ is forced to a concave curve relative to the platform 120) and contacts the ribs 160, 162. The leg portions 12a′, 12c′ generally abut the ribs 160, 162, respectively. With this in mind, and with additional reference to FIG. 6C, the height and width components H_{2nd}, W_{2nd} of the second profile 124 can be selected in accordance with expected, corresponding dimensions of the particular flexible profile molding 10′ being worked on, and in particular to effectuate and support the above described concave curvature in the connecting portion 12b′ while arranging the leg portions 12a′, 12c′ to be substantially parallel (e.g., within 10% of a truly parallel relationship) in the flexed cutting condition. For example, the height H_{2nd} of the ribs 160, 162 is selected to contact the connecting portion 12b′ when concavely flexed. The width W_{2nd} established by the ribs 160, 162 accommodates a desired distance between the leg portions 12a′, 12c′ when the connecting portion 12b′ is flexed. Finally, the gap 164 is sized and shaped to receive the flexed connecting portion 12b′. With other constructions of the flexible profile molding 10′ having geometries or dimensional relationships differing from those implicated by FIG. 8, one or more of the height H_{2nd}, width W_{2nd}, or gap 164 dimensional attributes can vary accordingly.

The cutting plate 32′ can include one or more of the additional indicia, mounting, and/or viewing features described above with respect to the cutting plate 32. For example, the cutting plate 32′ can include the first and second profile indicia 100, 102, the capture slots 110a, 110b, the grooves 114a, 114b, the bores 116 and/or the viewing pocket(s) 118 described above. Further, the cutting plate 32′ optionally includes article identification indicia 104′. With cross-reference between FIGS. 3B and 6B, the article identification indicia 104, 104′ is formatted to provide an indication of the size or type of flexible profile molding for which the particular cutting plate 32, 32′ is best suited. For example, in some embodiments, the tool 30 is useful with flexible profile moldings in the form of adhesive attachment article products from 3M Company, St. Paul, Minn. under the trade designation IMPACT PROTECTION PROFILE. The IMPACT PROTECTION PROFILE product is available in two styles or sizes designated as BP700 and BP950. With this in mind, in one embodiment, the first cutting plate 32 is best suited for use with the BP700 style product, whereas the second cutting plate 32′ is best suited for use with the BP950 style product. The article identification indicia 104, 104′ reflect these intended end-use applications, with the article identification indicia 104 of the first cutting plate 32 being “700” and the article identification indicia 104′ of the second cutting plate 32′ being “950”. A wide variety of other article identification indicia 104, 104′ nomenclature is equally acceptable, and in other embodiments can be omitted.

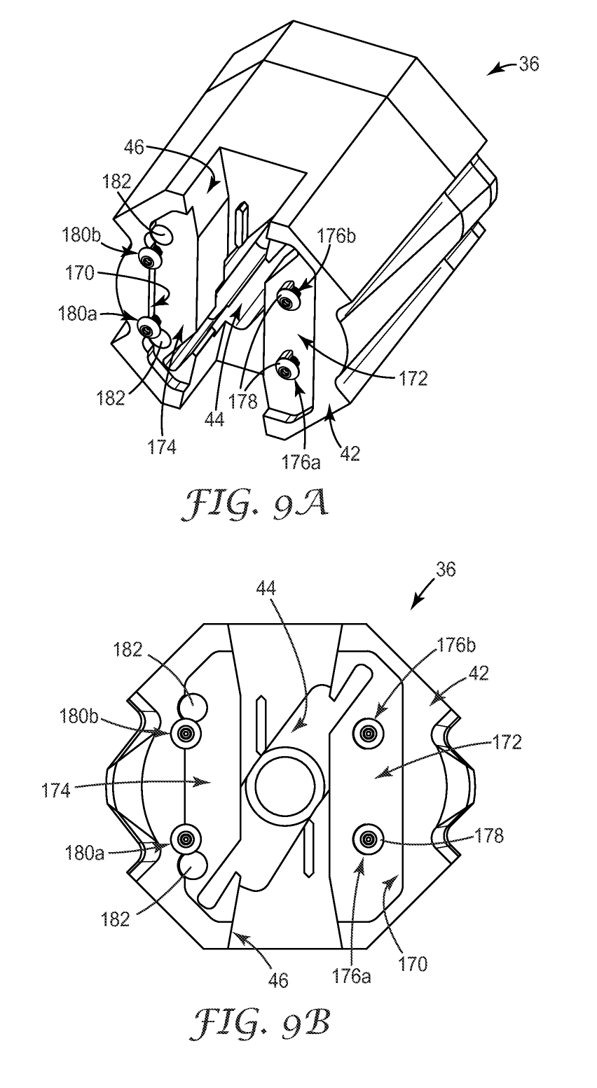

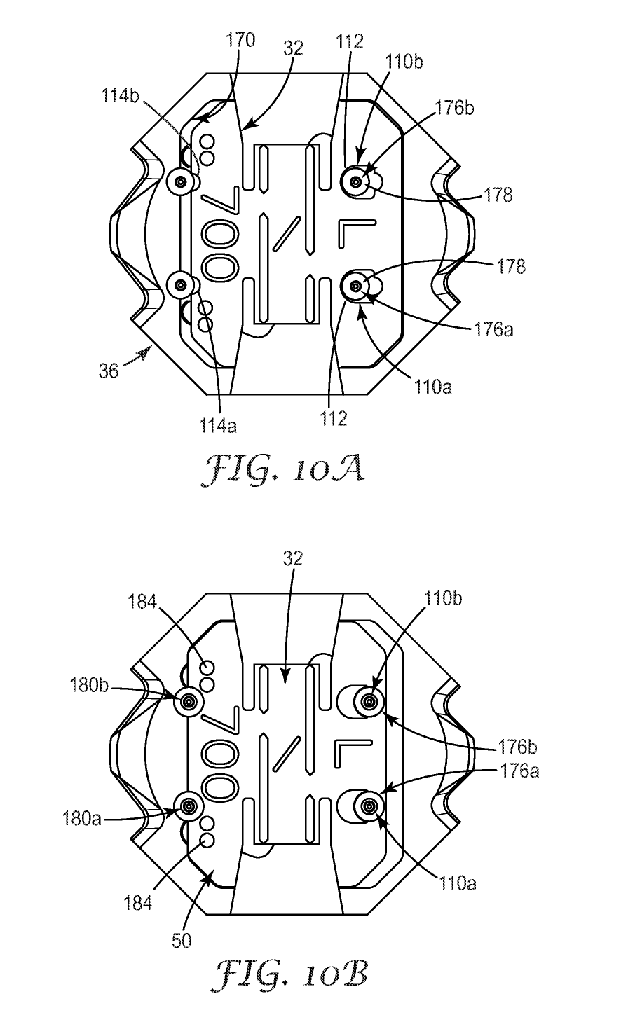

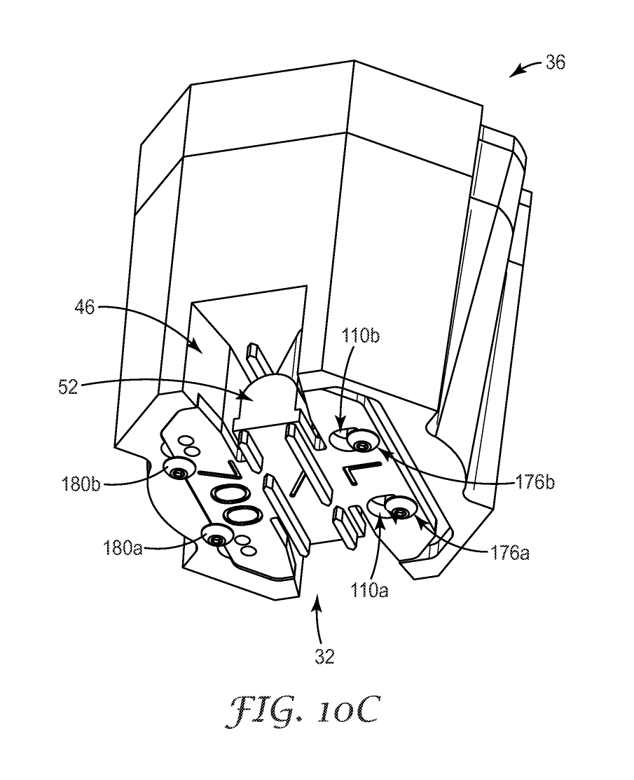

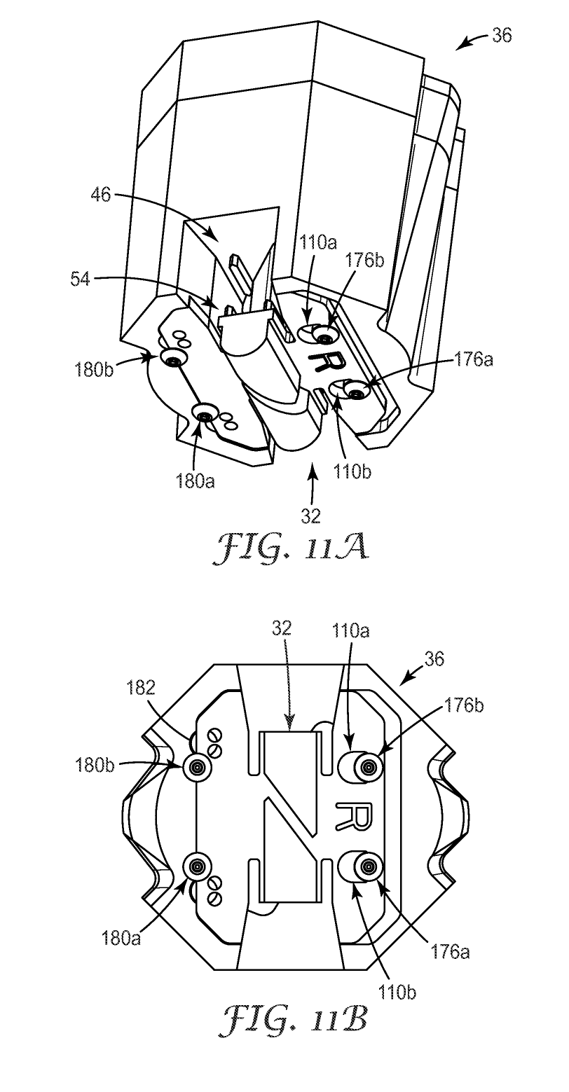

For ease of explanation, while the housing 36 is described in greater detail below in conjunction with a detailed explanation of the blade assembly 34, reference is initially made to FIGS. 9A and 9B otherwise illustrating optional features of the housing 36 that facilitate selective mounting of the cutting plate 32 (FIG. 3A), 32′ (FIG. 6A). In particular, FIGS. 9A and 9B show the second end 42 of the housing 36 in greater detail, and further reflect the cavity 44 and the slot 46 as being open to the second end 42. A recess 170 is formed in the second end 42, sized and shaped in accordance with a size and shape of a perimeter of the cutting plate 32 (and in particular of the platform 50 (FIG. 3A)). The recess 170 terminates at first and second floor portions 172, 174 that are separated by the slot 46. The first and second floor portions 172, 174 can be substantially flat (e.g., within 10% of a truly flat surface) and co-planar. First and second capture members 176a, 176b project from the first floor portion 172, each terminating at an enlarged head 178 that is longitudinally spaced from a face of the first floor portion 172. Similarly, first and second retention members 180a, 180b project from an edge of the recess 170 and are spaced above the second floor portion 174. In some embodiments, each of the members 176a, 176b, 180a, 180b is a screw or similar structure. A longitudinal spacing between the heads 178 and the first floor portion 172, as well as between the retention members 180a, 180b and the second floor portion 174, is commensurate with a thickness of the cutting plate platform 50 (FIG. 3A) for reasons made clear below. Finally, one or more magnets 182 can optionally be carried by or embedded into the housing 36 at the recess 170, for example at or adjacent the second floor portion 174 in close proximity to the retention members 180a, 180b.

Where provided, the capture members 176a, 176b and the retention member 180a, 180b are arranged in accordance with a geometry of the various mounting features provided with the cutting plate 32 (FIG. 3A), 32′ (FIG. 6A) and vice-versa. For example, FIG. 10A illustrates an initial stage of mounting of the cutting plate 32 to the housing 36. The cutting plate 32 is directed into the recess 170, and the capture slots 110a, 110b are placed over corresponding ones of the capture members 176a, 176b. In this regard, the enlarged end 112 of the capture slots 110a, 110b is larger than the capture member head 178, such that the head 178 is readily received within the corresponding slots 110a, 110b. The cutting plate 32 is then slid along the floor portions 172, 174 (best shown in FIG. 9A) to the final mounted arrangement of FIG. 10B. The platform 50 is captured between the head 178 of each of the capture members 176a, 176b and the first floor portion 172, as well as between each of the retention members 180a, 180b and the second floor portion 174. In this regard, with embodiments in which the retention member 180a, 180b are screws or similar structures, the grooves 114a, 114b (visible in FIG. 10A) provide necessary clearance. The assembled state of FIG. 10B is further augmented by a magnetic coupling between the magnets 182 (best seen in FIG. 9A) and metal dowels (referenced generally at 184) provided with the cutting plate 32. FIG. 10C provides another view of the final assembled state of FIG. 10B. The cutting plate 32 is easily uncoupled from the housing 36 in a reverse fashion, sliding the cutting plate 32 in a opposite direction (such that the capture member heads 178 now are located within the enlarged end 112 of the corresponding capture slot 110a, 110b) and then lifting the cutting plate 32 from the recess 170.

As a point of reference, FIGS. 10B and 10C reflect a first cutting state provided by tools of the present disclosure, with the cutting plate 32 arranged to locate the first profile 52 within the slot 46. Due to a symmetrical arrangement of the various mounting components, the cutting plate 32 can readily be mounted in the second cutting state of FIGS. 11A and 11B in which the second profile 54 is located within the slot 46. Once again, the capture members 176a, 176b are received within a respective one of the capture slots 110a, 110b, with the retention members 180a, 180b and the optional magnets 182 establishing a more robust connection.

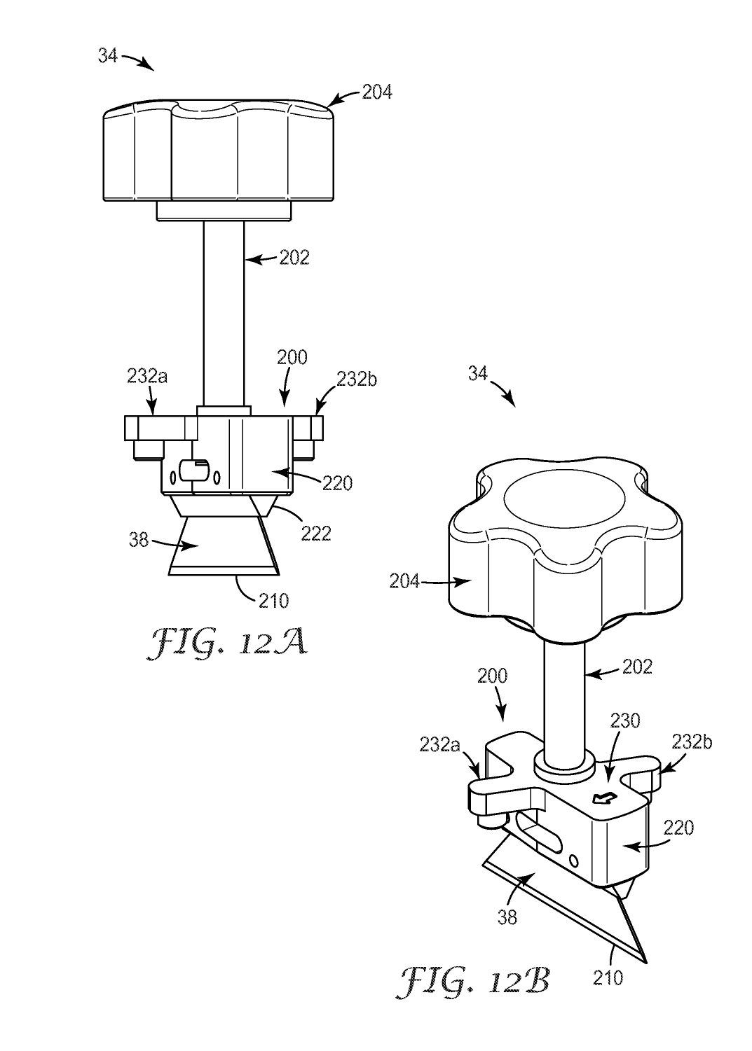

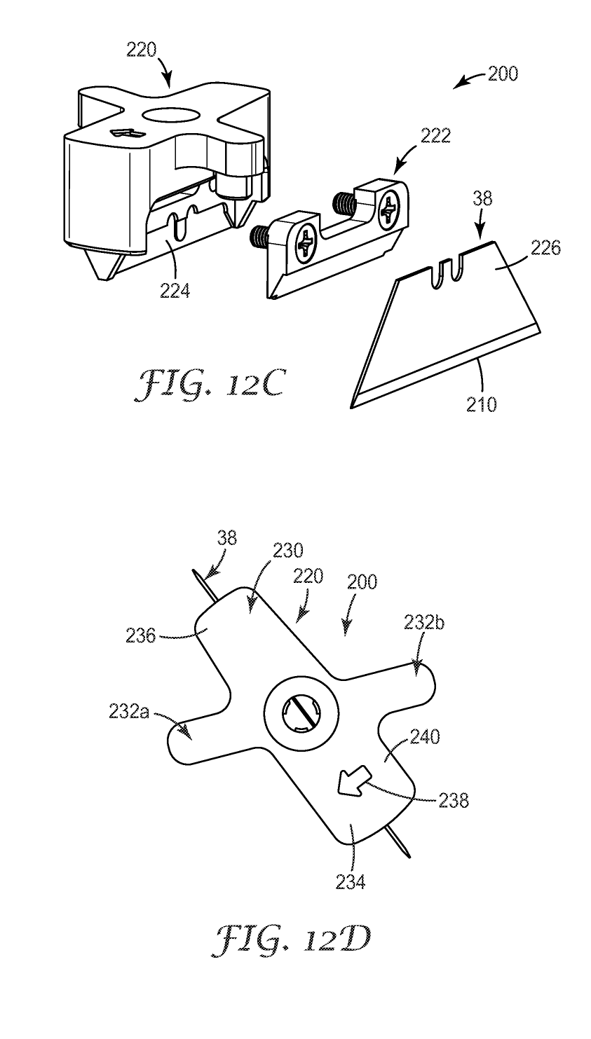

Returning to FIGS. 2A and 2B, other features of the housing 36 are best understood with reference to features of the blade assembly 34. With this in mind, the blade assembly 34 is configured to consistently interface with a flexible profile molding maintained by the cutting plate 32 (or the cutting plate 32′ (FIG. 6A)) regardless of the particular cutting plate profile being employed. Components of one embodiment of the blade assembly 34 are shown in greater detail in FIGS. 12A and 12B, and include the blade 38, a clamp structure 200, a shaft 202, and an actuator knob 204. The blade 38 is coupled to the clamp structure 200 that in turn is secured to the shaft 202. The knob 204 is connected to the shaft 202 opposite the clamp structure 200 such that upon final assembly, a force applied to the knob 204 is transferred onto the blade 38. As a point of reference, the tool 30 (FIG. 2B) can be configured such that a downward or pressing force is experienced by the shaft 202 in effectuating a cutting action by the blade 38 relative to the cutting plate 32 (FIG. 2B) as described below. In some embodiments, the shaft 202 is threaded so that the downward motion of the blade 38 is effected by user rotation of the knob 204. This optional construction provides mechanical advantage when cutting the flexible profile molding with the blade 38. Regardless, the blade assembly 34 optionally further includes one or more biasing devices (e.g., compression springs) 206 as shown in FIG. 2B that serve to bias the clamp structure 200, and thus the blade 38, to a neutral position away from the cutting plate 32.

In some embodiments, the blade 38 has a flattened construction, terminating in a linear cutting end 210. For example, the blade 38 can be a conventional utility knife blade, razor blade, or other type of straight blade. With these constructions, the blade 38 is a relatively inexpensive component, and can be replaced when dulled with a readily available replacement blade. That is to say, because installation tools of the present disclosure do not require a unique, curved blade to effectuate the desired miter cuts, a dulled blade is inexpensively and readily replaced. In other embodiments, however, the cutting end 210 can have a compound or curved shape.

The clamp structure 200 can assume various formats conducive to releasable mounting of the blade 38. For example, in some embodiments, the clamp structure 200 includes a base 220 and a plate 222. As best shown in FIG. 12C, the base 220 forms a recess 224 sized to receive a shoulder 226 of the blade 38. The plate 222, in turn, is configured for assembly to the base 220 (e.g., via screws or other fasteners) over the shoulder 226, thus locking the blade 38 to the base 220. Other clamp structure 200 configurations appropriate for maintaining the blade 38, optionally releasably maintaining the blade 38, are also acceptable.

Returning to FIGS. 12A and 12B, in some embodiments, the blade assembly 34 optionally incorporates additional features that, in combination with other components of the tool 30 (FIG. 2A), promote guided arrangement of the blade 38 at two (or more) spatial orientations. For example, the clamp structure 200 can form, for example as part of the base 220, a guide member or surface 230 and optional fingers 232a, 232b. As best reflected by FIG. 12D, the guide member 230 is aligned with a direction or arrangement of the blade 38 upon final assembly to the base 220 (i.e., the guide member 230 is contiguously formed with the blade mounting recess 224 (FIG. 12C) such that the guide member 230 and the blade 38 are co-planar or parallel). A length or major dimension of the guide member 230 is less than that established by a footprint of the blade 38 such that a perimeter of the blade 38 extends outwardly beyond the footprint of the guide member 230. Further, the guide member 230 can be characterized as defining opposing, first and second ends 234, 236, with the guide member 230 tapering in the width direction from the first end 234 to the second end 236 for reasons made clear below.

The fingers 232a, 232b, where provided, are configured for mounting to a respective one of the biasing devices 206 (FIG. 2A). The fingers 232a, 232b can project from opposing sides of the guide member 230 along a common axis. The fingers 232a, 232b are configured to slidably interface with corresponding features of the housing 36 (FIG. 2B) as described below.

In general terms, upon final assembly of the tool 30 (FIG. 2A), the guide member 230 interfaces with other components or features of the tool 30 in establishing one of two available spatial orientations of the blade 38 relative to the cutting plate 32 (FIG. 2B) in a manner maintaining the selected orientation as the blade 38 is translated through a cutting motion. The fingers 232a, 232b each retain one of the biasing devices 206 (FIG. 2B) in either spatial orientation, and are generally received by the housing 36 (FIG. 2A) in a manner permitting translation of the blade 38 in the longitudinal direction. In other configurations, the blade assembly 34 can have a more simplified construction that may or may not promote multiple blade orientations. With embodiments in which two (or more) blade orientations are provided, an indicator 238 or other indicia can optionally be formed or provided on a face 240 of the guide member 230 that assists a user in visually confirming a selected blade orientation following final assembly of the tool 30 as described below.

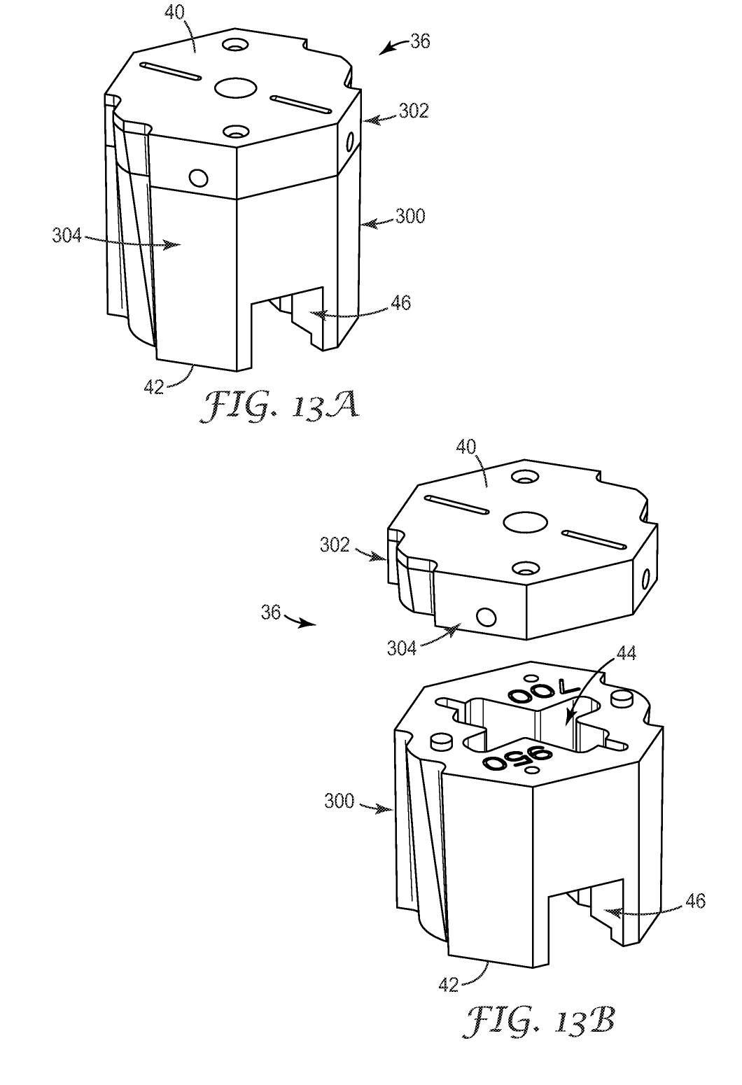

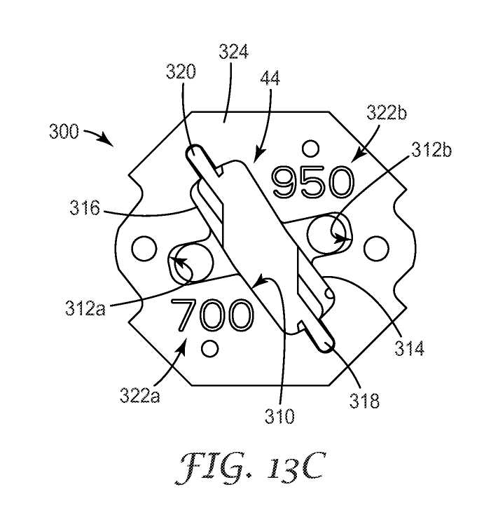

Returning to FIGS. 2A and 2B, the housing 36 is configured to slidably maintain the blade assembly 34. The housing 36 is shown in greater detail in FIGS. 13A and 13B, and generally defines the opposing, first and second ends 40, 42. In some embodiments, the housing 32 includes a housing body 300 and an optional cover 302 that, upon final assembly, serve to collectively form the housing ends 40, 42 (i.e., the cover 302 defines the first end 40, and the housing body 300 forms the second end 42). In other embodiments, the housing 36 can have a more integral or homogenous construction. Regardless, the housing 36 forms various features that facilitate assembly and operation of the tool 30 in performing a flexible profile molding miter cut action, including the cavity 44 and the slot 46. In general terms, the cavity 44 extends longitudinally (i.e., along the longitudinal axis A (FIG. 2A)), and is configured to maintain the blade assembly 34 (FIG. 2B) in a manner dictating a selected spatial orientation of the blade 38 (FIG. 2B) as described in greater detail below. The slot 46 extends transversely to, and is open to, the cavity 44, and is configured to generally receive and position a flexible profile molding (not shown) for cutting by the blade assembly 34. In this regard, the cutting plate 32 (FIG. 2B) robustly establishes an flexed cutting condition or arrangement of the flexible profile molding within the slot 46. Finally, an exterior 304 (referenced generally) of the housing 36 is optionally configured to facilitate alignment of the flexible profile molding relative to surfaces of an installation environment (e.g., a window). Each of these features is described in greater detail below.

The cavity 44 can assume various configurations, and is open to at least the second end 42. For example, with embodiments including the separate housing body 300 and cover 302 components, the cavity 44 is primarily defined by the housing body 300 and extends along the central longitudinal axis A (FIG. 2A). In particular, the cavity 44 as generated by the housing body 300 is configured in combination with features of the blade assembly 34 (FIG. 2B) to establish a spatial orientation of the blade 38 (FIG. 12A), and guide movement of the blade 38 along this so-dictated orientation. With this in mind, in some embodiments, the cavity 44, at least along housing body 300, is sized and shaped in accordance with the guide member 230 (FIG. 12D) and the fingers 232a, 232b (FIG. 12D) to provide two different blade orientations. For example, and as best reflected by the view of FIG. 13C, the cavity 44 can be described as having or defining a guide channel 310 and finger channels 312a, 312b. The guide channel 310 is generally configured to slidably receive the guide member 230, maintaining a selected spatial orientation of the guide member 230 (and thus of the blade 38 attached thereto) as the blade 38 is moved in a direction of the longitudinal axis A when articulated through a cutting motion. In some embodiments, the guide channel 310 can be described as having opposing, first and second end regions 314, 316. While the guide channel end regions 314, 316 can have a substantially identical, uniform width that is commensurate with a width of the guide member first end 234 (FIG. 12D), the first end region 314 is arranged at a slight angle relative to the second end region 316. Thus, while extension of the guide channel 310 in the radial direction defines a linear length that directly corresponds with a length of the guide member 230, the angularly off-set arrangement of the first end region 314 relative to the second end region 316 effectuates a differing spatial orientation of the guide member 230 as a function of which end region 314, 316 fully captures the guide member 230. Smaller width blade channels 318, 320 are formed as radial extensions of the guide channel end regions 314, 316, respectively, and are sized and shaped to slidably receive a perimeter edge of the blade 38 that otherwise extends outwardly beyond a footprint of the guide member 230.

The finger channels 312a, 312b are configured to generally receive a corresponding one of the fingers 232a, 232b (FIG. 12D), and are open to the guide channel 310. In this regard, projection of the finger channels 312a, 312b from the guide channel 310 is at an angle commensurate with that established between the guide member 230 (FIG. 12D) and the fingers 232a, 232b. For reasons made clear below, a width of each of the finger channels 312a, 312b is slightly larger than a width of the fingers 232a, 232b.

Finally, orientation indicia 322a, 322b can be formed or provided on a face 324 of the housing body 300, arranged to facilitate visual confirmation to a user of a selected blade orientation. The orientation indicia 322a, 322b can assume various formats, and in some embodiments are indicative of a particular adhesive attachment article type or size. For example, in some embodiments, the tool 30 is useful with flexible profile moldings in the form of adhesive attachment article products from 3M Company, St. Paul, Minn. under the trade designation IMPACT PROTECTION PROFILE. The IMPACT PROTECTION PROFILE product is available in two types or sizes designated as BP700 and BP950. The exemplary orientation indicia 322a, 322b reflects this but one acceptable end use, with the first orientation indicia 322a being “700” and the second orientation indicia 322b being “950”. A wide variety of other orientation indicia 322a, 322b nomenclature is also envisioned, and is in no way limited to explicit or implicit reference to a particular flexible profile molding trade designation, style, or size.

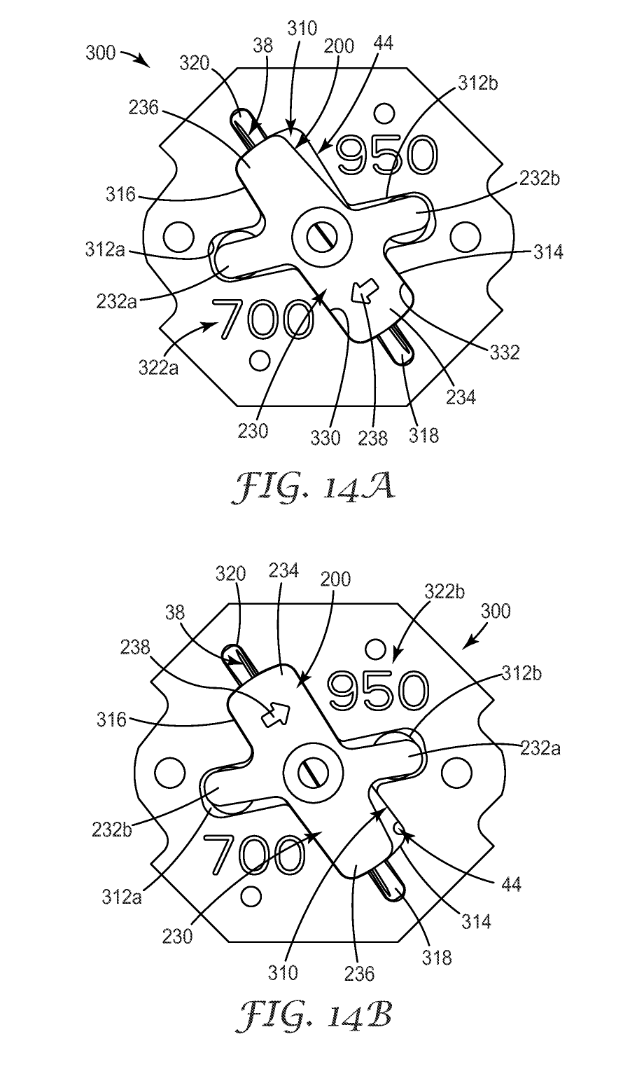

As implicated by the above explanations, the blade assembly clamp structure 200 and the cavity 44 are configured in tandem to establish two spatial orientations of the blade 38 in some embodiments. For example, FIG. 14A illustrates the clamp structure 200 mounted to the cavity 44 at a first spatial orientation of the blade 38. The guide member 230 is slidably captured within the guide channel 310, including opposing sides edges 330, 332 of the wider first end 234 of the guide member 230 slidably abutting surfaces of the housing body 300 otherwise establishing the first end region 314 of the guide channel 310. The interface between the guide member first end 234 and the housing body 300 prevents the base 220 from rotating within or relative to the cavity 44. The second end 236 of the guide member 230 is narrower in width, and thus has a less complete interface with surfaces of the guide channel 310 at the second end region 316 thereof. In other words, the guide member 230 is fully captured at the guide channel first end region 314 and not at the guide channel second end region 316, with the first end region 314 thus establishing a spatial orientation of the clamp structure 200, and thus of the blade 38. Outer portions of the blade 38 otherwise extending radially beyond a footprint of the guide member 230 are slidably disposed within the blade channels 318, 320. The first finger 232a is generally or loosely received within the first finger channel 312a, and the second finger 232b is generally received within the second finger channel 312b. Upon final assembly, then, the clamp structure 200, and thus the blade 38, can be longitudinally articulated relative to the housing body 300 (i.e., along a direction of the longitudinal axis A, or into and out of the page of FIG. 14A), with a sliding, abutting interface between the guide member 230 and surfaces of the housing body 300 maintaining the spatial orientation of blade 38 relative to the housing body 300. The finger channels 312a, 312b permit corresponding longitudinal movement of the fingers 232a, 232b. Notably, in this first spatial orientation, the indicator 238 is arranged to “point” at or otherwise implicate the first orientation indicia 322a.

FIG. 14B illustrates the clamp structure 200 mounted within the cavity 44 at the second spatial orientation of the blade 38. As compared to the first spatial orientation of FIG. 14A, the clamp structure 200 has been rotated approximately, but not exactly, 180 degrees. The guide member 230 is again slidably captured within the guide channel 310, but with the wider first end 234 now being fully captured within the second end region 316 of the guide channel 310. The narrower second end 236 is generally received within the first end region 314 of the guide channel 310. In other words, with the arrangement of FIG. 14B, the second end region 316 establishes the spatial orientation of the clamp structure 200, and thus of the blade 38 (as compared to the first end region 314 with the arrangement of FIG. 14A). Due to the angularly off-set arrangement of the first and second end regions 314, 316 relative to one another, then, the second spatial orientation of the blade 38 is not 180 degrees relative to the first spatial orientation (it being understood that because the cutting end 210 (FIG. 12A) of the blade 38 is linear or flat, were the blade 38 rotated exactly 180 degrees between the first and second spatial orientations (as would otherwise be the case were the first and second end regions 314, 316 linearly arranged relative to one another), the spatial arrangement of the plane of the cutting end 210 would be identical). Outer portions of the blade 38 otherwise extending radially beyond a footprint of the guide member 230 are again slidably disposed within the blade channels 318, 320. The first finger 232a is generally or loosely received within the second finger channel 312b, and the second finger 232b is generally received within the first finger channel 312a. Upon final assembly, the clamp structure 200, and thus the blade 38, can be longitudinally articulated relative to the housing body 300 (i.e., along a direction of the longitudinal axis A, or into and out of the page of FIG. 14B) as described above. Notably, in this second spatial orientation, the indicator 238 is arranged to “point” at or otherwise implicate the second orientation indicia 322b.

Returning to FIGS. 2A and 2B, the cover 302 is configured to secure the clamp structure 200 and the blade 38 within the cavity 44 upon final assembly and in a manner that facilitates desired longitudinal movement of the blade assembly 34 as part of a cutting operation. For example, the cover 302 forms a bore 330 that is sized to slidably receive the shaft 202, but is smaller than a foot print of the clamp structure 200. With this construction, the clamp structure 200 is captured relative to the housing body 300 (and thus relative to the cavity 44), with the bore 330 allowing the shaft 202 to slide or articulate in the longitudinal direction, for example in response to an actuating force placed upon the knob 204. The cover 302 is removably attached to the housing body 300 (e.g., screws) in some embodiments. With this construction, the blade 38 can be replaced and/or arranged at a different spatial orientation by simply removing the cover 302 from the housing body 300.

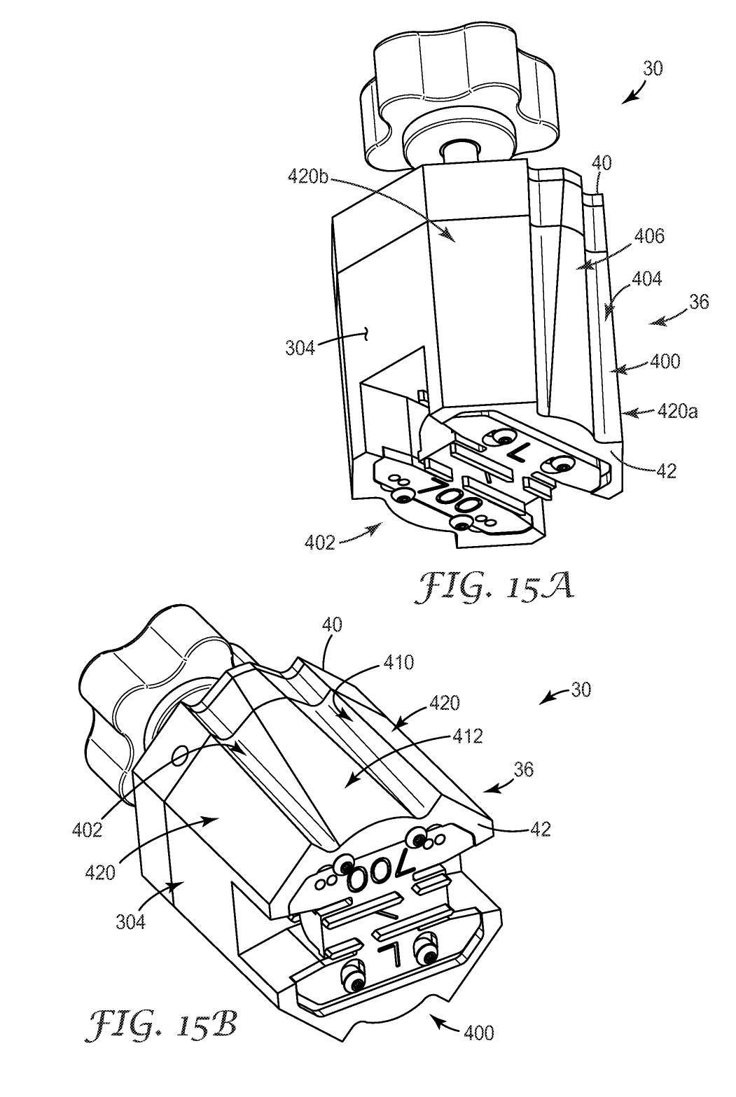

As previously mentioned, an additional optional feature of the housing 36 is the provision of various features along the exterior 304 that are useful in aligning a flexible profile molding relative to a substrate surface, for example aligning an adhesive attachment article relative to a window during the installation process. In some embodiments, the exterior 304 includes or defines first alignment surface 400 and an optional second alignment surface 402 as best shown in FIGS. 15A and 15B, respectively. In general terms, the alignment surfaces 400, 402 provide a contour configured to slidably engage a flexible profile molding being applied to a substrate. In this regard, the contour of the first alignment surface 400 can differ from that of the second alignment surface 402, rendering the tool 30 useful in installing two different types or sizes of flexible profile moldings.

Although the contours differ, the alignment surfaces 400, 402 have similar characteristics that may be commensurate with the expected shape of the flexible profile molding as applied to the installation environment. As a point of reference, in some embodiments, the installation environment requires that the flexible profile molding be flexed upon final installation (e.g., as shown in FIG. 1C). This flexed condition can be referred to as a “flexed installation condition” and is contrasted with the “flexed cutting condition” described above with respect to the cutting plate 32 (FIG. 3A), 32′ (FIG. 6A). With this in mind, and with specific reference to FIG. 15A, the first alignment surface 400 generally includes or defines a trough 404 extending in the longitudinal direction between the first and second ends 40, 42. The trough 404 is sized in accordance with an expected width of the corresponding flexible profile molding (in a flexed installation condition as applied to surface(s) of the installation environment, such as a window), and can taper in size or width from the second end 42 to the first end 40 (or vice-versa). In this regard, a width of the trough 404 at the second end 42 is larger than the overall width of the corresponding flexible profile molding (in the flexed installation condition), such that the flexible profile molding will readily “enter” or “lead in to” the trough 404 at the second end 42. Conversely, a width of the trough 404 at the first end 40 more closely approximates an overall width of the corresponding flexible profile molding (in the flexed installation condition), and thus a more robust engagement is achieved at and adjacent the first end 40.

An optional ridge 406 is centrally formed within the trough 404, and extends from and between the first and second ends 40, 42. As with the taper of the trough 404, a shape of the ridge 406 progressively changes from the second end 42 to the first end 44. In particular, the ridge 406 defines an arch-like shape or contour (e.g., a curved face) that is progressively more pronounced along a longitudinal length of the housing 36 from the second end 42 to the first end 40 (e.g., a height (in the radial direction) of the ridge 406 increases from the second end 42 to the first end 40). With this construction, the less pronounced shape of the ridge 406 at the second end 42 presents a minimal obstruction to a flexible profile molding “entering” the trough at the second end 42. As contact between the first alignment surface 400 and the corresponding flexible profile molding progresses toward the first end 40, however, the more pronounced shape of the ridge 406 promotes robust engagement with the ridge 406, forcing the flexible profile molding to a desired shape.

With additional reference to FIG. 15B, where provided the second alignment surface 402 can be highly similar to the first alignment surface 400, and includes a trough 410 extending in the longitudinal direction between the first and second ends 40, 42. The trough 410 can taper in width from the second end 42 to the first end 40 as described above. An optional ridge 412 is centrally formed within the trough 410, and exhibits a progressively pronounced shape from the second end 42 to the first end 40. As compared to the first alignment surface 400, the trough 410 has a larger width, and a shape of the ridge 412 is larger or more pronounced, especially at the first end 40.

In some embodiments, the housing exterior 304 forms positioning flats 420 at opposite sides of the alignment surfaces 400, 402. For example, FIG. 15A identifies first and second positioning flats 420a, 420b at opposite sides of the first alignment surface 400. The positioning flats 420 are substantially flattened (e.g., within 5% of a truly flat surface), and are configured to slidably interface with a flat surface associated with the installation environment (e.g., a window) during use of the corresponding alignment surface 400, 402 in aligning a flexible profile molding to the installation environment. In this regard, the opposing positioning flats 420 (e.g., the first and second positioning flats 420a, 420b) can be arranged at an approximately 90 degree angle (i.e., a plane of the first positioning flat 420a and a plane of the second positioning flat 420b form a 90 degree angle) commensurate with the surfaces expected to be encountered in a window installation environment. In other embodiments, the alignment surfaces 400, 402 and/or the positioning flats 420 can assume a variety of other forms. In yet other embodiments, some or all of the alignment surfaces 400, 402 and the positioning flats 420 can be omitted.

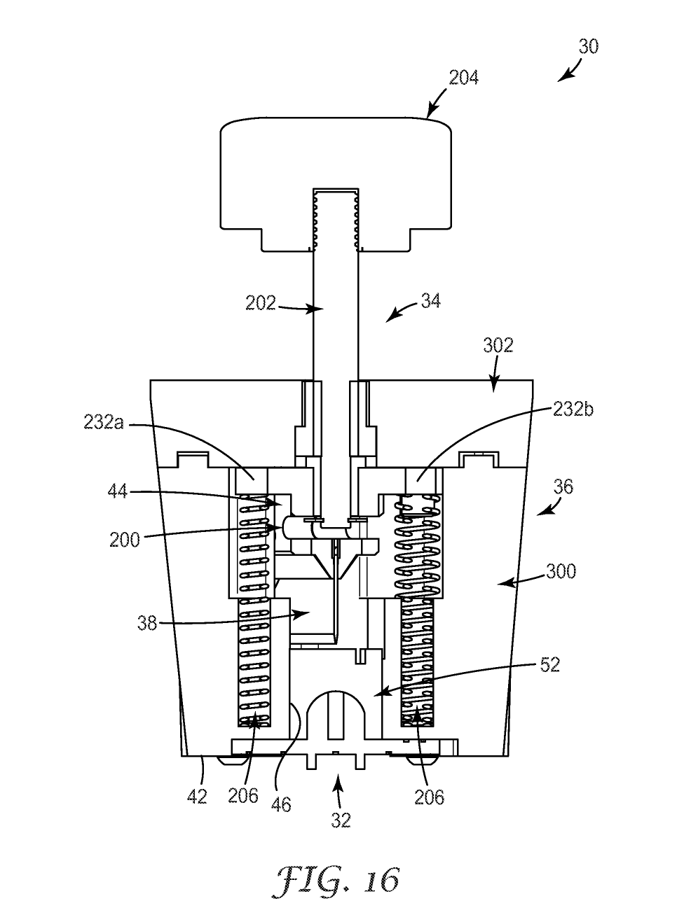

Final construction of the tool 30 is generally reflected in FIG. 16. The blade assembly 34 is coupled to the housing 36, including the clamp structure 200 and the blade 38 disposed with the cavity 44 as described above. The biasing devices 206 are mounted to the fingers 232a, 232b and are captured within the housing body 300. The biasing devices 206 bias the clamp structure 200, and thus the blade 38, to the neutral or raised position shown, with the clamp structure 200 abutting against the cover 302. The shaft 202 extends through the cover 302, and locates the actuator knob 204 for convenient interface by a user. The cutting plate 32 is mounted to the second end 42 of the housing 36, with FIG. 16 representing an arrangement of the cutting plate 32 in the first cutting state (i.e., with the first profile 52 located within the slot 46 and facing or proximate the blade 38). A cutting operation includes a user applied force at the actuator knob 204 (e.g., rotation, pressing force, etc.) creating sufficient downward force on the clamp structure 200 to overcome a bias (e.g., spring force) of the biasing devices 206. As a result, the blade 38 is caused to move downwardly toward the cutting plate 32, contacting (and severing) material retained within the slot 46 and along the first profile 52.

The tool 30 is highly useful in performing one or more tasks associated with installation of flexible profile moldings, for example installation of adhesive attachment articles to a window film-protected window. Some non-limiting examples of methods in accordance with principles of the present disclosure are described below in the context of installing adhesive attachment articles to a window; it will be understood, however, that some or all of the described methodologies are equally applicable to other types of flexible profile moldings and to other installation environments. In some embodiments, the tool 30 can be provided as part of a kit or system that includes the first and second cutting plates 32 (FIG. 3A), 32′ (FIG. 6A) described above. Under these circumstances, the installer can first determine the type or size of adhesive attachment article (or other flexible profile molding) to be installed, and then select the cutting plate 32, 32′ best suited for the particular adhesive attachment article. In related embodiments in which the tool 30 is configured to provide the differing, first and second spatial orientations of the blade 38, the installer can also determine the spatial orientation best suited for the particular adhesive attachment article (or other flexible profile molding) and confirm that the blade 38 is arranged at the desired spatial orientation as described above.

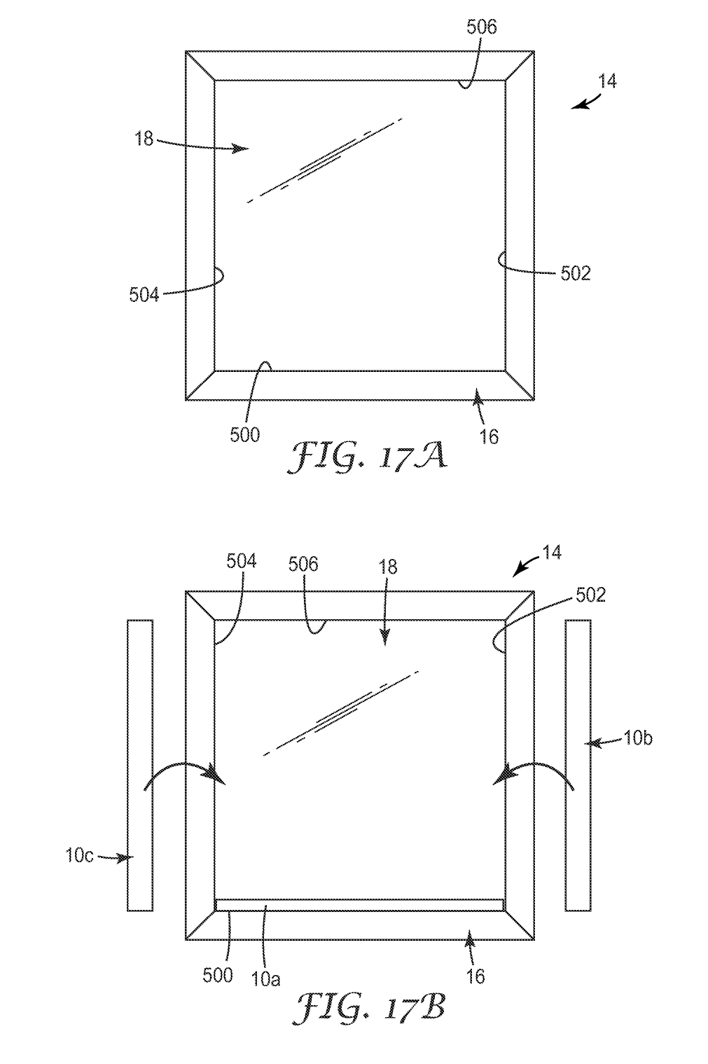

Once the tool 30 is generally prepared for a cutting operation, the installer evaluates the installation environment to determine the type of cut(s) to be formed. For example, FIG. 17A schematically illustrates one exemplary installation environment in the form of the widow 14 that includes or forms four side edges 500-506 between the window frame 16 and the glazing 18 (to which a window film (transparent in the view) has previously been applied). The installation process will thus generally include application of a separate adhesive attachment article (or other flexible profile molding) along each of the side edges 500-506, with each adhesive attachment article possibly requiring one or more miter cuts prior to, or simultaneously with, application to the window 14. In this regard, a variety of different techniques can be employed for deciding upon the order in which the adhesive attachment articles are applied to respective ones of the side edges 500-506, and the particular order may implicate the formation of one or two miter cuts. By way of example, FIG. 17B illustrates a first adhesive attachment article 10a applied to the first side edge 500. A second adhesive attachment article 10b to be applied to the adjacent, second side edge 502 can optimally include a first type of miter cut (e.g., a right end miter cut) at the end that will otherwise overlap the previously applied, first adhesive attachment article 10a. Conversely, a third adhesive attachment article 10c to be applied to the adjacent, third side edge 504 can optimally include a second type of miter cut (e.g., a left end miter cut) at the end that will otherwise overlap the previously applied, first adhesive attachment article 10a. A plethora of other installation techniques are equally acceptable, and for each adhesive attachment article (or other flexible profile molding) to be installed, can implicate the formation of a first type of miter cut, a second type of miter cut, or a straight cut at one or both of the opposing ends thereof.

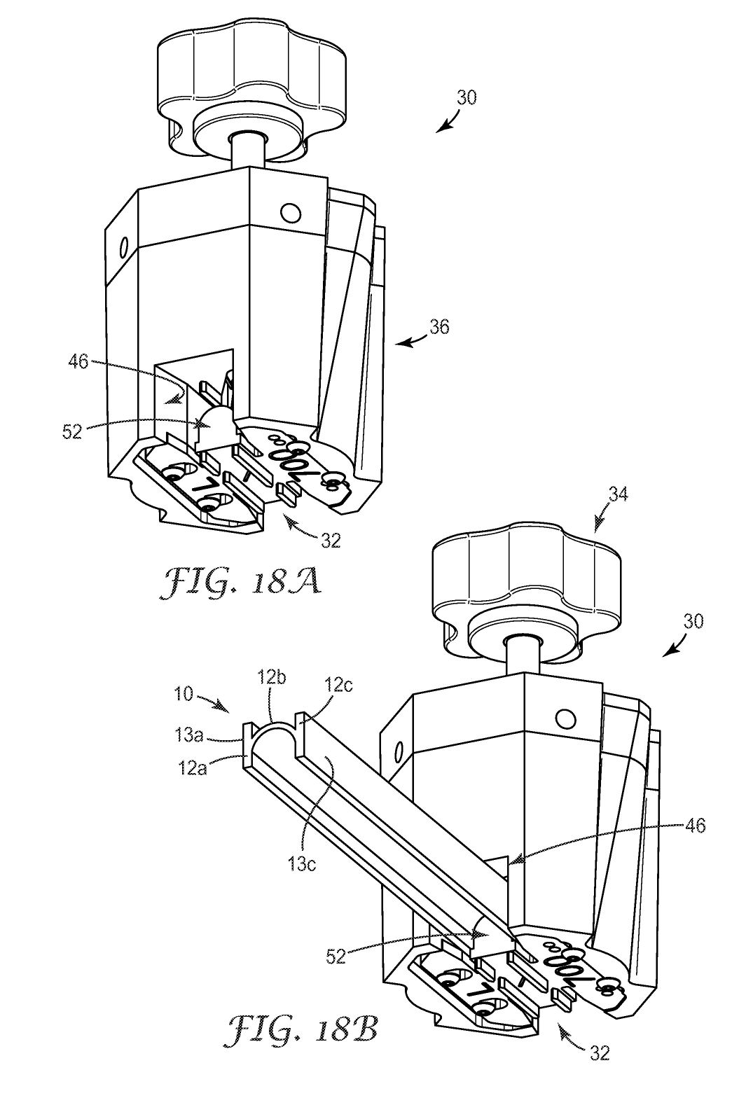

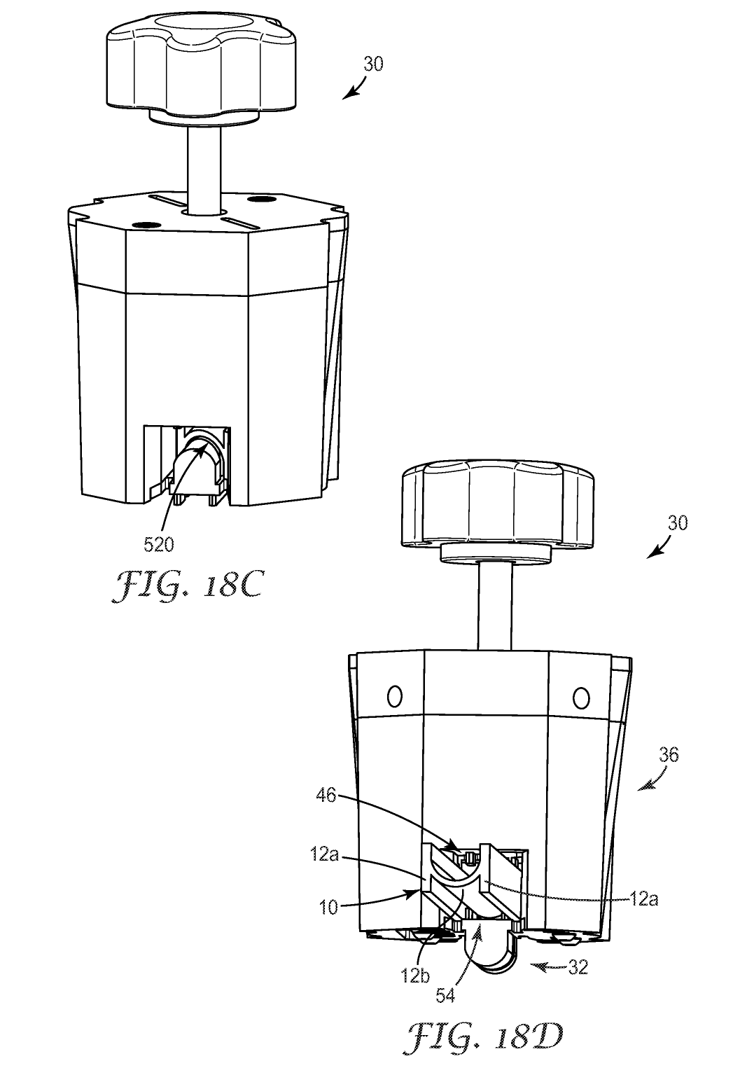

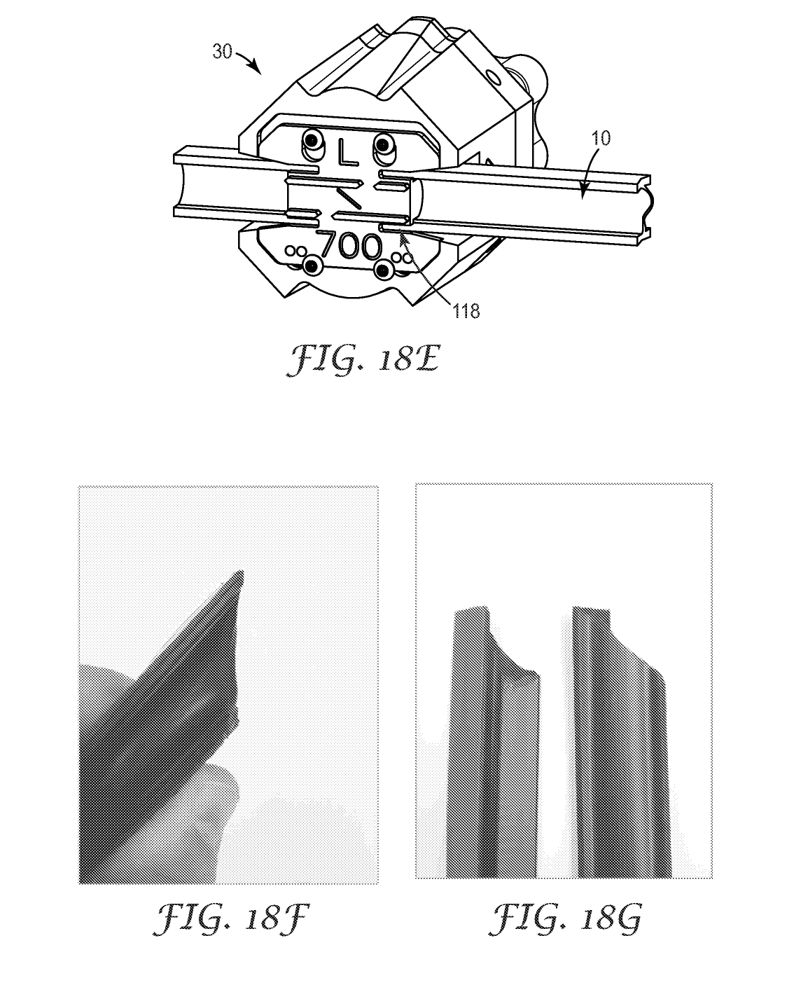

Once a decision has been made that a miter cut is to be formed and further the type of miter cut to be generated, the cutting plate 32 (or 32′) is coupled to the housing 36 in the corresponding arrangement as described above. For example, FIG. 18A illustrates the cutting plate 32 arranged to position the first profile 52 within the slot 46 (and corresponding with a left end miter cut). The adhesive attachment article 10 is then inserted into the slot 46 as shown in FIG. 18B. Interface between the adhesive attachment article 10 and the first profile 52 forces the adhesive attachment article 10 to flex and assume the flexed cutting condition or shape of FIG. 18B. In some embodiments, the installer may wish to manually flex or bend the adhesive attachment article 10 to a shape generally corresponding with the first profile 52 to make insertion of the adhesive attachment article (or other flexible profile molding) 10 into the slot 46 easier. Regardless, the connecting portion 12b is forced to the generally convex shape shown, whereas the leg portions 12a, 12c are held in a substantially parallel arrangement. As a point of reference, the adhesive surfaces 13a, 13c are further identified in FIG. 18B. The blade assembly 34 is then operated to force the blade 38 (FIG. 2B) through the adhesive attachment article 10, forming the miter cut end 520 generally referenced in FIG. 18C. By holding the leg portions 12a, 12c in a substantially parallel arrangement, a desired contoured miter cut is formed using the otherwise straight blade 38. FIG. 18D illustrates the cutting plate 32 arranged to position the second profile 54 within the slot 46, and a flexed cutting condition or shape forced into the adhesive attachment article (or other flexible profile molding) 10 upon insertion into the slot 46. Similar arrangements are provided by the second cutting plate 32′ (FIG. 6A) and the corresponding flexible profile molding 10′ (FIG. 7). When desired, a user can evaluate a location of the to-be-formed cut along a length of the flexible profile molding 10 immediately prior to initiating the cutting motion via the viewing pocket(s) 118 as reflected in FIG. 18E.

By arranging the flexible profile molding in the flexed cutting condition or shape, the tool 30 is uniquely configured to effectuate a contoured (e.g., partially curved) miter cut using an otherwise flat or straight blade. For example, FIG. 18F is a photograph depicting the miter cut end formed in a flexible profile molding by tools of the present disclosure. As a point of reference, in the photograph of FIG. 18F, the flexible profile molding is forced to the flexed cutting condition, with the miter cut end being relatively straight or linear (via cutting by the straight or flat blade). The photograph of FIG. 18G illustrates the same, miter cut flexible profile molding of FIG. 18F, but with the flexible profile molding allowed to revert back toward a natural, un-flexed condition. In this condition, the miter cut end now exhibits non-linear contours or curvatures.

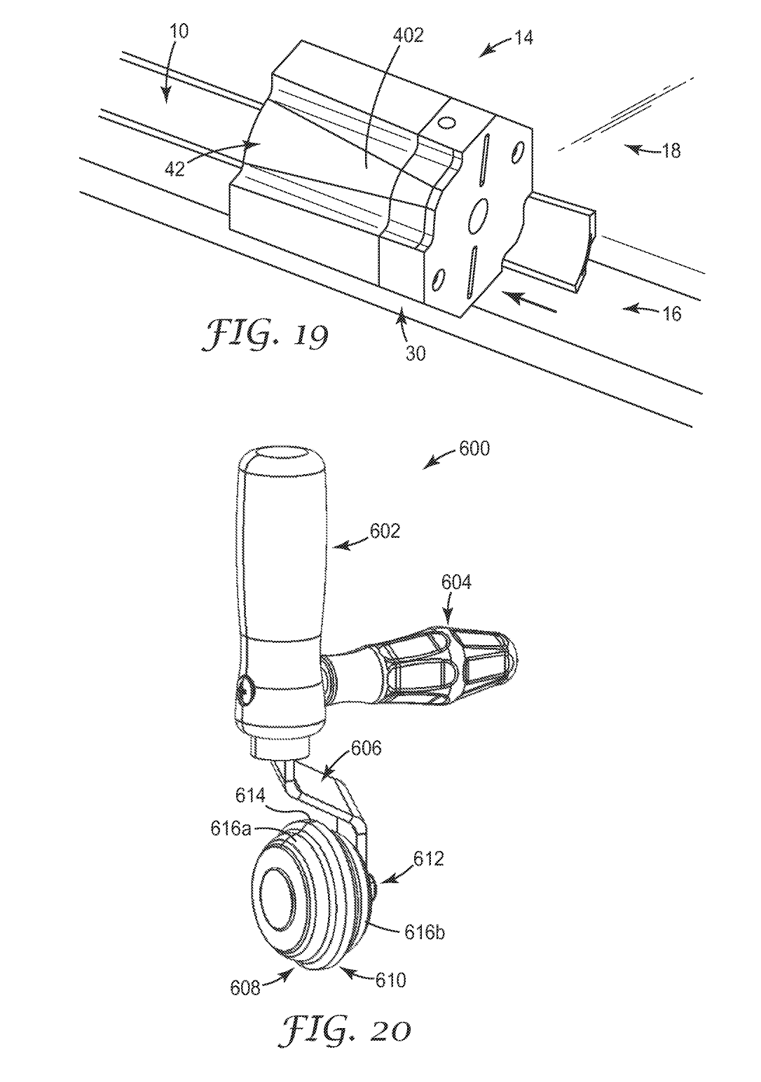

Once the desired miter cut(s), if any, have been formed, the flexible profile molding in question can then be applied to the window 14 (or other installation environment). For example, and as previously described with reference to FIG. 1C, the flexible profile molding can be the adhesive attachment article 10 that is generally applied to the window 14 such that the first leg portion 12a adhesively contacts the glazing 18 (and more particularly, the window film 20 applied thereto), and the second leg portion 12c adhesively contacts the window frame 16. The flexible connecting portion 12b is flexed to obtain this exemplary flexed installation condition in which the first and second portions 12a, 12c are substantially perpendicular (e.g., within 10 percent of a truly perpendicular relationship). To achieve more consistent or uniform surface area of contact between the leg portions 12a, 12c and the corresponding window components, the alignment surface 400, 402 corresponding with the particular type or size of the adhesive attachment article 10 can be utilized to assist in this task as shown in FIG. 19. FIG. 19 reflects the first alignment face 400 (hidden in the view but shown in FIG. 15A) disposed over the adhesive attachment article 10 as it is being applied to the window 14. The first alignment surface 400 is slid along the adhesive attachment article 10 in the direction of installation (identified by an arrow in FIG. 19). The positioning flats 420 (hidden in the view) slidingly abut the window frame 16 and the glazing 18, thus maintaining a consistent, straight path of travel of the tool 30. In this regard, the second end 42 of the housing 36 serves as the “leading” side of the tool 30 along the path of travel, with the more subtle contour of the first alignment surface 400 at the second end 42 readily receiving and interfacing with the adhesive attachment article 10.

Following aligned application of the adhesive attachment article 10 (or other flexible profile molding) to the window 14 (or other installation environment), the installer may wish to further activate the adhesive bond (with flexible profile moldings that include an adhesive). In this regard, some embodiments of the present disclosure include an optional, roller tool 600 shown in FIG. 20. The roller tool 600 includes first and second handles 602, 604, a shaft 606 and a roller assembly 608. The second handle 604 extends from the first handle 602, with the handles 602, 604 providing two available grasping surfaces. The shaft 606 extends from the first handle 602, and is connected to the roller assembly 608. The roller assembly 608 includes a roller 610 and a roller mechanism 612 (referenced generally) that rotatably supports the roller 610 relative to the shaft 606. The roller 610 is beneficially configured for interfacing with the applied adhesive attachment article 10 (FIG. 1C), and defines an intermediate region 614 and opposing side regions 616a, 616b. The opposing side regions 616a, 616b progressively increase in diameter toward the intermediate region 614, and are configured to fully contact the leg portions 12a, 12c (FIG. 1C) of the applied adhesive attachment article 10. The intermediate region 614 represents a stepped outer diameter (as compared to the side regions 616a, 616b) and is configured to fully contact the flexed connecting portion 12b (FIG. 1C) of the applied adhesive attachment article (or other flexible profile molding) 10. During use, the installer is able to grasp the roller tool 600 at both of the handles 602, 604 and then align the roller 610 on to the applied adhesive attachment article 10. Significant pressure can then be exerted by the installer onto the applied adhesive attachment article 10, pressing deeply into the adhesive attachment article 10 to ensure the adhesive surfaces 13a, 13c (FIG. 1C) receive sufficient pressure.

The installation tools of the present disclosure provide a marked improvement over previous designs. Desired miter cuts can be quickly and consistently formed in flexible profile moldings, such as those commonly used for securing an applied window film to a window frame. In this regard, the installation tools of the present disclosure are capable of forming what is effectively a curved miter cut with a simple flat or straight blade. Further, the installation tools of the present disclosure can form two types of desired miter cuts (e.g., right end miter cut and left end miter cut), via a reversible cutting plate. In some embodiments, two or more cutting plates are available for working on differing sizes or styles of flexible profile moldings, and in related embodiments, the cutting blade can be spatially maintained in at least two orientations corresponding with the differently-sized flexible profile moldings.

Although the present disclosure has been described with reference to preferred embodiments, workers skilled in the art will recognize that changes can be made in form and detail without departing from the spirit and scope of the present disclosure.

### EXEMPLARY EMBODIMENTS

1. An installation tool for installing an elongate flexible profile molding to a substrate, the tool comprising:
a housing defining a cavity and opposing, first and second ends;
a blade assembly coupled to the housing and including a blade disposed within the cavity; and
a cutting plate selectively mountable to the second end of the housing, the cutting plate including:
   a platform defining opposing, first and second major faces,
   a first profile projecting from the first major face,
   an optional second profile projecting from the second major face,
   wherein the first profile and the optional second profile are configured to retain an elongate flexible profile molding, the first profile differing from the second profile when provided;
wherein selective mounting of the cutting plate to the second end of the housing defines a first cutting state in which the first profile faces the blade and an optional second cutting state in which the second profile, when provided, faces the blade.

2. The installation tool of embodiment 1, wherein the flexible profile molding includes an adhesive.

3. The installation tool of embodiment 2, wherein the adhesive is a pressure sensitive adhesive.

4. The installation tool of embodiment 1, wherein the housing further defines a slot open to the second end.

5. The installation tool of embodiment 4, wherein the slot is open at opposing sides of the housing for receiving an elongate flexible profile molding.

6. The installation tool of embodiment 5, wherein the cutting plate is configured to arrange the first profile in a direction of the slot in the first cutting state and the second profile, when present, in a direction of the slot in the second cutting state.

7. The installation tool of embodiment 6, wherein the second profile is present, and further wherein the first and second profiles are configured such that in the first and second cutting states, respectively, an elongate flexible profile molding is held in arrangement flexed cutting condition dictated by the corresponding profile for cutting by the blade.

8. The installation tool of embodiment 1, wherein the first profile has an arch shape.

9. The installation tool of embodiment 1, wherein the first profile includes a support wall projecting from the first major face and terminating at a leading edge opposite the first major face, the leading edge forming a curve.

10. The installation tool of embodiment 9, wherein the support wall further defines opposing side edges extending between the leading edge and the first major face, the side edges being substantially planar.

11. The installation tool of embodiment 9, wherein the support wall defines a notch sized to receive the blade.

12. The installation tool of embodiment 9, wherein the housing further defines a slot configured to receive an elongate flexible profile molding, and further wherein the first cutting state includes the leading edge extending in a direction of the slot.

13. The installation tool of embodiment 9, wherein the first cutting state includes the leading edge being proximate the blade.

14. The installation tool of embodiment 1, wherein the second profile is present, and further wherein the second profile includes first and second spaced apart ribs projecting from the second major face.

15. The installation tool of embodiment 14, wherein a notch is formed through each of the ribs and sized to receive the blade.

16. The installation tool of embodiment 14, wherein the ribs have an elongated shape, and further wherein the housing defines a slot configured to receive an elongate flexible profile molding, and even further wherein the second cutting state includes the ribs extending in a direction of the slot.

17. The installation tool of embodiment 1, wherein the blade assembly further includes a biasing mechanism biasing the blade away from the cutting plate, and further wherein the installation tool is configured to effectuate severing of an elongate flexible profile member mounted to the cutting plate via a user-applied force sufficient to overcome a biasing force of the biasing mechanism.

18. The installation tool of embodiment 1, wherein the blade is a utility knife blade.

19. The installation tool of embodiment 1, wherein the blade is a straight blade.

20. The installation tool of embodiment 1, wherein the blade assembly further includes a guide member, and further wherein the cavity defines a guide channel configured to selectively capture a region of the guide member in establishing a spatial orientation of the blade relative to the cutting plate.

21. The installation tool of embodiment 20, wherein the guide channel forms a first end region configured to arrange the guide member at a first spatial orientation relative to the cutting plate, and a second end region configured to arrange the guide member at a second spatial orientation relative to the cutting plate.

22. The installation tool of embodiment 21, wherein the first end region is angularly off-set from the second end region.

23. The installation tool of embodiment 1, wherein the housing forms an exterior defining a first alignment surface configured to apply an elongate flexible profile molding to a window.

24. The installation tool of embodiment 23, wherein the first alignment surface is configured to slidably receive an elongate flexible profile molding.

25. The installation tool of embodiment 23, wherein the housing exterior further forms a second alignment surface configured to slidably receive a flexible profile molding, and further wherein a contour of the first alignment surface differs from a contour of the second alignment surface.

26. The installation tool of embodiment 23, wherein the first alignment surface includes:
a trough extending from the first end to the second end;
wherein a width of the trough is defined in a direction perpendicular to a length of the housing;
and further wherein the width of the trough at the first end differs from the width of the trough at the second end.

27. The installation tool of embodiment 26, wherein the trough tapers in width between the first and second ends.

28. The installation tool of embodiment 26, wherein each of the alignment faces further includes a ridge formed within, and extending along a length of, the corresponding trough, and further wherein the ridge forms a curved face for slidably interfacing with an elongate flexible profile molding.

29. The installation tool of embodiment 23, wherein the exterior of the housing further defines positioning flats adjacent the first alignment surface, the positioning flats configured to slidably engage a flat surface.

30. A method of installing a flexible profile molding having an un-flexed shape in a natural condition, the method comprising:
inserting the flexible profile molding into an installation tool, including the installation tool forcing the flexible profile molding to a flexed cutting condition having a flexed cutting shape differing from the un-flexed shape;
actuating the installation tool to cut the flexible profile molding while in the flexed cutting condition to define a flexible profile molding segment having a miter cut end;
removing the flexible profile molding segment from the installation tool such that flexible profile molding segment is free to revert back toward the natural condition;
wherein the miter cut end is substantially linear in the flexed cutting condition and has a curved contour in the natural condition; and
locating the flexible profile molding segment at an installation environment.

31. The method of embodiment 30, wherein the installation tool includes a straight blade, and the step of actuating the installation tool to cut the flexible profile molding includes cutting the flexible profile molding with the straight blade.

32. The method of embodiment 31, wherein the step of locating the flexible profile molding segment at an installation environment includes flexing the flexible profile molding segment to a flexed installation condition having a flexed shape differing from the un-flexed shape and the flexed shape of the flexed cutting condition.

33. The method of embodiment 32, wherein the flexible profile molding defines opposing leg portions interconnected by a flexible connection portion, and further wherein the flexed cutting condition includes the opposing leg portions arranged substantially parallel and the flexed installation condition includes the opposing leg portions arranged substantially perpendicular.

34. The method of embodiment 30, wherein the flexible profile molding is an adhesive attachment article.

35. The method of embodiment 34, wherein the installation environment is a window film-protected window.

1. An installation tool for installing an elongate flexible profile molding to a substrate, the tool comprising:
a housing defining a cavity and opposing, first and second ends;
a blade assembly coupled to the housing and including a blade disposed within the cavity; and
a cutting plate selectively mountable to the second end of the housing, the cutting plate including:
a platform defining opposing, first and second major faces,
a first profile projecting from the first major face,
an optional second profile projecting from the second major face,
wherein the first profile and the optional second profile are configured to retain an elongate flexible profile molding, the first profile differing from the second profile when provided;
wherein selective mounting of the cutting plate to the second end of the housing defines a first cutting state in which the first profile faces the blade and an optional second cutting state in which the second profile, when provided, faces the blade.

2. The installation tool of claim 1, wherein the housing further defines a slot open to the second end, wherein the slot is open at opposing sides of the housing for receiving an elongate flexible profile molding.

3. The installation tool of claim 2, wherein the cutting plate is configured to arrange the first profile in a direction of the slot in the first cutting state and the second profile, when present, in a direction of the slot in the second cutting state.

4. The installation tool of claim 3, wherein the second profile is present, and further wherein the first and second profiles are configured such that in the first and second cutting states, respectively, an elongate flexible profile molding is held in arrangement flexed cutting condition dictated by the corresponding profile for cutting by the blade.

5. The installation tool of claim 1, wherein the first profile includes a support wall projecting from the first major face and terminating at a leading edge opposite the first major face, the leading edge forming a curve.

6. The installation tool of claim 5, wherein the support wall further defines opposing side edges extending between the leading edge and the first major face, the side edges being substantially planar.

7. The installation tool of claim 5, wherein the housing further defines a slot configured to receive an elongate flexible profile molding, and further wherein the first cutting state includes the leading edge extending in a direction of the slot.

8. The installation tool of claim 5, wherein the first cutting state includes the leading edge being proximate the blade.

9. The installation tool of claim 1, wherein the second profile is present, and further wherein the second profile includes first and second spaced apart ribs projecting from the second major face, and wherein a notch is formed through each of the ribs and sized to receive the blade.

10. The installation tool of claim 1, wherein the blade assembly further includes a biasing mechanism biasing the blade away from the cutting plate, and further wherein the installation tool is configured to effectuate severing of an elongate flexible profile member mounted to the cutting plate via a user-applied force sufficient to overcome a biasing force of the biasing mechanism.

11. The installation tool of claim 1, wherein the blade is a straight blade.

12. The installation tool of claim 1, wherein the blade assembly further includes a guide member, and further wherein the cavity defines a guide channel configured to selectively capture a region of the guide member in establishing a spatial orientation of the blade relative to the cutting plate.

13. The installation tool of claim 12, wherein the guide channel forms a first end region configured to arrange the guide member at a first spatial orientation relative to the cutting plate, and a second end region configured to arrange the guide member at a second spatial orientation relative to the cutting plate.

14. The installation tool of claim 1, wherein the housing forms an exterior defining a first alignment surface configured to apply an elongate flexible profile molding to a window.

15. The installation tool of claim 14, wherein the first alignment surface includes:
a trough extending from the first end to the second end;
wherein a width of the trough is defined in a direction perpendicular to a length of the housing;
and further wherein the width of the trough at the first end differs from the width of the trough at the second end.

16. The installation tool of claim 15, wherein each of the alignment faces further includes a ridge formed within, and extending along a length of, the corresponding trough, and further wherein the ridge forms a curved face for slidably interfacing with an elongate flexible profile molding.

17. A method of installing a flexible profile molding having an un-flexed shape in a natural condition, the method comprising:
inserting the flexible profile molding into an installation tool, including the installation tool forcing the flexible profile molding to a flexed cutting condition having a flexed cutting shape differing from the un-flexed shape;
actuating the installation tool to cut the flexible profile molding while in the flexed cutting condition to define a flexible profile molding segment having a miter cut end;
removing the flexible profile molding segment from the installation tool such that flexible profile molding segment is free to revert back toward the natural condition;
wherein the miter cut end is substantially linear in the flexed cutting condition and has a curved contour in the natural condition; and
locating the flexible profile molding segment at an installation environment.

18. The method of claim 17, wherein the installation tool includes a straight blade, and the step of actuating the installation tool to cut the flexible profile molding includes cutting the flexible profile molding with the straight blade.

19. The method of claim 18, wherein the step of locating the flexible profile molding segment at an installation environment includes flexing the flexible profile molding segment to a flexed installation condition having a flexed shape differing from the un-flexed shape and the flexed shape of the flexed cutting condition.

20. The method of claim 19, wherein the flexible profile molding defines opposing leg portions interconnected by a flexible connection portion, and further wherein the flexed cutting condition includes the opposing leg portions arranged substantially parallel and the flexed installation condition includes the opposing leg portions arranged substantially perpendicular.
